(19) United States
(12) Patent Application Publication
(10) Pub. No.: US 2026/0057027 A1
(43) Pub. Date: Feb. 26, 2026

(54) SCALING LEARNING OF RENDERING HINTS FOR A DOMAIN COMPRISING NUMEROUS WEB PAGES

(71) Applicant: Snappi. Inc., Carlsbad, CA (US)

(72) Inventors: Peter J. Lepeska, Boston, MA (US); James M. Hepburn, Quincy, MA (US)

(21) Appl. No.: 19/376,131

(22) Filed: Oct. 31, 2025

Related U.S. Application Data
(63) Continuation of application No. PCT/US2021/038132, filed on Jul. 17, 2025.
(60) Provisional application No. 63/673,109, filed on Jul. 18, 2024.

(51) Int. Cl. G06F 16/957; G06F 16/955

(52) U.S. Cl. CPC G06F 16/957; G06F 16/955

(57) ABSTRACT

Web page loading may be improved by leveraging structural similarities across pages within a domain. Web pages are categorized into page types, and representative samples are analyzed to identify common and unique blocking resources. Real user monitoring data is used to refine these resource lists. When a page is requested, predicted blocking resources are used to generate optimization hints, improving loading performance and scalability for large websites.

### CROSS-REFERENCE TO RELATED APPLICATIONS

This application claims priority to and is a bypass continuation of International Patent Application No. PCT/US2025/038132, filed Jul. 17, 2025, and entitled “SCALING LEARNING OF RENDERING HINTS FOR A DOMAIN COMPRISING NUMEROUS WEB PAGES” (VS2628-WO-1).

International Patent Application No. PCT/US2025/038132 claims the benefit of Provisional Patent Application Ser. No.: U.S. 63/673,109, filed Jul. 18, 2024, and entitled “SCALING LEARNING OF RENDERING HINTS FOR A DOMAIN COMPRISING NUMBEROUS WEB PAGES” (VS2501-US-1).

Each of the foregoing applications is incorporated herein by reference in its entirety for all purposes.

### BACKGROUND

Webpages are made up of numerous resources, including images, scripts, stylesheets, fonts, and other media files, which browsers must fetch and/or access, often from remote/non-local storage/servers, to render a webpage's content fully. These resources vary widely in their importance and impact on the user experience. While some resources are essential for displaying the primary content (e.g., above-the-fold content, such as key images, main text, and layout styling), other elements are less critical. For example, images located further down the webpage, background scripts, or secondary styling may be non-essential for immediate functionality and visual presentation when the page first loads.

Fetching every resource simultaneously, regardless of its relevance to the initial display, can lead to inefficient use of bandwidth and increase load times. When non-essential resources compete for network bandwidth and processing power with high-priority elements, they create unnecessary delays in displaying primary content, causing the page to feel slower and less responsive. This can lead to a frustrating user experience, particularly on slower networks or devices with limited processing power, where every additional resource can further slow the loading process.

By selectively prioritizing the resources for the initial render of the webpage, such as main text and visible images, developers can reduce the amount of data a browser needs to process immediately, reducing the time it takes for users to see and interact with the content. Resources that do not impact the first visible area and/or immediate functionality, like images lower down the page, can be deferred or loaded asynchronously, ensuring that they do not consume valuable bandwidth or CPU resources during the critical first moments.

Traditional approaches to improving webpage responsiveness often focus on providing a browser with URLs for a webpage's resources, where the browser fetches the various resources from the webpage's hosting server and/or various thirst-party servers (e.g., servers not underneath a same domain as the webpage). Such approaches, however, suffer from high bandwidth and/or processing demands on the browser, which, in turn, impede the webpage's responsiveness.

Other traditional approaches push resources to the browser. In such approaches, however, the pushing server lacks knowledge of what resources the browser may already have in its cache, and, as such, often pushes unneeded resources to the browser which, in turn, consumes the browser's network and/or computing resources—thus impeding the webpage's responsiveness. Further, such traditional approaches typically require multiple network connections between the pushing server and the browser which also impedes the webpage's responsiveness.

Hinting is a technique in web performance optimization that provides for prioritizing resources that are needed for rendering events. Hints may indicate which resources should be preloaded, prefetched, or prioritized based on their impact on the user experience and they help browsers make decisions about loading sequences, especially for resources that are essential for initial display and interactivity. Without hinting, browsers may load resources in a default, less optimal order, fetching non-essential elements that delay the rendering of visible content. Through hints, key resources can be loaded promptly, reducing perceived wait times and enhancing page responsiveness.

### SUMMARY

The systems, apparatuses and/or methods disclosed herein provide for improved snappiness of a webpage and/or website.

In some aspects, the techniques described herein relate to a computer-implemented method, including: sampling pages from a domain to determine a URL to page-type mapping that maps a plurality of URLs to a plurality of page-types; sampling a subset of pages, from the domain, for each identified page-type of the plurality of page-types and analyzing the subset of pages to identify a list of common blocking resources and a list of distinct blocking resources for a page-type of the plurality of page-types; refining, based at least in part on real user monitoring (RUM) feedback, the list of common blocking resources and the list of distinct blocking resources for a first page; and storing the refined list of common blocking resources and the refined list of distinct blocking resources for the first page, wherein the list of common blocking resources and the list of distinct blocking resources are associated with a first URL and the page-type of the first page.

In some aspects, the techniques described herein relate to a computer-implemented method further including: performing testing by: receiving a request for a second URL; predicting, from the refined list of common blocking resources and the refined list of distinct blocking resources, a set of blocking resources for the second URL; comparing the set of blocking resources with a known set of blocking resources; and calculating an accuracy metric based on the comparing.

In some aspects, the techniques described herein relate to a computer-implemented method, wherein the list of common blocking resources and the list of distinct blocking resources include blocking resources that impact a snappiness of the first page.

In some aspects, the techniques described herein relate to a computer-implemented method, wherein identifying distinct blocking resources includes analyzing locations within a document object model (DOM) of the first page to extract resource identifiers.

In some aspects, the techniques described herein relate to a computer-implemented method, wherein determining the URL to page-type mapping includes receiving page-type information from RUM data.

In some aspects, the techniques described herein relate to a computer-implemented method, wherein determining the URL to page-type mapping includes: receiving page-type classification data from an external analytics system; and associating the received page-type classification with corresponding URLs.

In some aspects, the techniques described herein relate to a computer-implemented method, wherein page-types include at least one of product or collection.

In some aspects, the techniques described herein relate to a computer-implemented method, wherein determining the URL to page-type mapping includes: comparing the URL to page-type mapping using a regular expression.

In some aspects, the techniques described herein relate to a computer-implemented method, further including: receiving a request for a second URL; mapping the second URL to a page-type of the plurality of page-types; identifying common blocking resource sets for the page-type mapped to the second URL; identifying distinct blocking resource sets for the second URL; and combining the common blocking resource sets and the distinct blocking resource sets to predict a set of blocking resources for the second URL.

In some aspects, the techniques described herein relate to a computer-implemented method, further including: generating hints from the set of blocking resources for the second URL, wherein the hints are used to at least one of prefetch or prioritize resources.

In some aspects, the techniques described herein relate to a computer-implemented method, further including: learning, via a trained machine learning model, to identify one or more page-types based on one or more corresponding HTML files of a page or a URL of a page; wherein the determination of the URL to page-type mapping is based at least in part on the trained machine learning model.

In some aspects, the techniques described herein relate to a computer-implemented method, wherein learning the URL to page-type mapping includes: obtaining page URLs for the domain; grouping the page URLs into different page-types; identifying URL patterns for each page-type; and storing a list of patterns that identify page-types for the domain.

In some aspects, the techniques described herein relate to a computer-implemented method for optimizing webpage loadings, including: analyzing a plurality of webpages and identifying common blocking resources and distinct blocking resources for each page-type of the plurality of webpages; processing real user monitoring (RUM) data to refine the distinct blocking resources for individual pages within each page-type; and processing a user request for a first webpage to predict blocking resources from the common blocking resources and the refined distinct blocking resources for the first webpage.

In some aspects, the techniques described herein relate to a computer-implemented method further including: performing testing by: receiving a request for a first URL; predicting, based on the refined distinct blocking resources, a set of blocking resources for the first URL; comparing the set of blocking resources with a known set of blocking resources; and calculating an accuracy metric based on the comparing.

In some aspects, the techniques described herein relate to a computer-implemented method, wherein the refined distinct blocking resources include resources that impact snappiness.

In some aspects, the techniques described herein relate to a computer-implemented method, wherein each page-type of the plurality of webpages corresponds to at least one of product or collection.

In some aspects, the techniques described herein relate to a computer-implemented method, wherein identifying the common blocking resources and the distinct blocking resources for each page-type of the plurality of webpages includes: processing using a trained machine learning model.

In some aspects, the techniques described herein relate to a computer-implemented method, wherein identifying the common blocking resources and the distinct blocking resources for each page-type of the plurality of webpages includes: comparing URLs using a regular expression.

In some aspects, the techniques described herein relate to a computer-implemented method further including: generating hints from the common blocking resources and the refined distinct blocking resources.

In some aspects, the techniques described herein relate to a computer-implemented method for predicting blocking resources for webpages, including: receiving a request for a page URL; mapping the page URL to a page-type; identifying common blocking resource sets associated with the page-type; identifying additional blocking resource sets specific to the page URL; combining the common blocking resource sets and the additional blocking resource sets to predict a combined set of blocking resources for the page URL; and transmitting the combined set of blocking resources.

In some aspects, the techniques described herein relate to a computer-implemented method, wherein the common blocking resource sets and the additional blocking resource sets include resources that impact a snappiness of a webpage of the page URL.

In some aspects, the techniques described herein relate to a computer-implemented method further including: optimizing loading of a requested webpage by preloading the combined set of blocking resources.

In some aspects, the techniques described herein relate to a computer-implemented method, wherein mapping the page URL to the page-type includes: processing using a trained machine learning model.

In some aspects, the techniques described herein relate to a computer-implemented method, wherein mapping the page URL to the page-type includes: comparing the page URL and page-type mapping using regular expressions.

In some aspects, the techniques described herein relate to a computer-implemented method, further including: generating page hints for the page URL.

In some aspects, the techniques described herein relate to a computer-implemented method, wherein mapping the page URL to the page-type includes: grouping domain URLs into different page-types; identifying URL patterns for each page-type; and storing a list of patterns that identify page-types for the domain URLs.

In some aspects, the techniques described herein relate to a computer-implemented method, wherein the common blocking resource sets and the additional blocking resource sets include resources that impact a snappiness of a webpage of the page URL.

In some aspects, the techniques described herein relate to a computer-implemented method, wherein the page-type is at least one of product or collection.

In some aspects, the techniques described herein relate to a computer-implemented method further including: learning, via a trained machine learning model, to identify one or more page-types based on one or more corresponding HTML files of a page or a URL of the page; wherein mapping the page URL to the page-type is based at least in part on the trained machine learning model.

In some aspects, the techniques described herein relate to a computer-implemented method, wherein learning includes: obtaining page URLs for a domain; grouping the page URLs into different page-types; identifying URL patterns for each page-type; and storing a list of patterns that identify page-types for the domain.

In some aspects, the techniques described herein relate to a computer-implemented method for optimizing rending of a webpage, including: analyzing URLs and identifying patterns to categorize webpages into a plurality of page-types; performing page-type training by: sampling a subset of pages for each page-type of the plurality of page-types, analyzing the subset of pages to identify common blocking resources and distinct blocking resources, and storing the common blocking resources and the distinct blocking resources in a data storage component; and performing page training for each page-type by: obtaining data from real user monitoring (RUM) for one or more pages corresponding to the page-type; refining the distinct blocking resources for the one or more pages corresponding to the page-type; and transmitting the refined distinct blocking resources to the data storage component.

In some aspects, the techniques described herein relate to a computer-implemented method, wherein identifying distinct blocking resources includes analyzing locations within a document object model (DOM) of the webpage to extract resource identifiers.

In some aspects, the techniques described herein relate to a computer-implemented method further including: performing testing by: receiving a request for a first URL; predicting, via the common blocking resources and the refined distinct blocking resources, a set of blocking resources for the first URL; comparing the predicted set of blocking resources with a known set of blocking resources; and calculating an accuracy metric based on the comparing.

In some aspects, the techniques described herein relate to a computer-implemented method, wherein the common blocking resources and the refined distinct blocking resources include resources that impact snappiness of the webpage.

In some aspects, the techniques described herein relate to a computer-implemented method, wherein each page-type of the plurality of page-types corresponds to at least one of a product or a collection.

In some aspects, the techniques described herein relate to a computer-implemented method, wherein analyzing URLs and identifying patterns to categorize webpages into a plurality of identified pages-types includes: processing using a trained machine learning model.

In some aspects, the techniques described herein relate to a computer-implemented method, wherein analyzing URLs and identifying patterns to categorize webpages into a plurality of identified pages-types includes: comparing using a regular expression.

In some aspects, the techniques described herein relate to a computer-implemented method further including: generating hints from the common blocking resources and the refined distinct blocking resources.

In some aspects, the techniques described herein relate to a computer-implemented method for optimizing webpage loadings, including: sampling a subset of webpages from a domain to obtain a representative set of page-types; analyzing the sampled webpages to identify shared blocking resources and distinct blocking resources for each page-type; analyzing real user monitoring (RUM) feedback to derive distinct resources for each webpage of the subset; storing the shared blocking resources and the distinct resources for each page-type in a data storage component; training a machine learning model using the stored data to categorize webpages from the domain into the representative set of page-types; predicting blocking resources for a requested webpage using the trained machine learning model; and optimizing loading of the requested webpages by generating preload hints for the predicted blocking resources.

In some aspects, the techniques described herein relate to a computer-implemented method further including: performing testing by: receiving a request for a first URL; predicting, via the shared blocking resources and the distinct blocking resources, a set of blocking resources for the first URL; comparing the set of blocking resources with a known set of blocking resources; and calculating an accuracy metric based on the comparing.

In some aspects, the techniques described herein relate to a computer-implemented method, wherein the shared blocking resources and the distinct blocking resources include resources that impact snappiness of the requested webpage.

In some aspects, the techniques described herein relate to a computer-implemented method, wherein each of the representative set of page-types corresponds to at least one of a product or a collection.

In some aspects, the techniques described herein relate to an apparatus including: at least one processor; and a memory device that stores an application that, when loaded into the at least one processor, causes the at least one processor to: sample pages from a domain to determine a URL to page-type mapping that maps a plurality of URLs to a plurality of identified page-types; sample a subset of pages, from the domain, for each identified page-type of the plurality of identified page-types and analyze the sampled subset of pages to identify a list of common blocking resources and a list of distinct blocking resources for an identified page-type of the plurality of identified page-types; refine, based at least in part on real user monitoring (RUM) feedback, the list of common blocking resources and the list of distinct blocking resources for a first page; and store the refined list of common blocking resources and the list of distinct blocking resources for the first page, wherein the list of common blocking resources and the list of distinct blocking resources are associated with a first URL and the page-type mapping of the first page.

In some aspects, the techniques described herein relate to an apparatus, wherein the application further causes the at least one processor to: perform testing by: receiving a request for a second URL; predict, via the refined list of common blocking resources and the list of distinct blocking resources, a set of blocking resources for the second URL; compare the set of blocking resources with a known set of blocking resources; and calculate an accuracy metric based on the comparing.

In some aspects, the techniques described herein relate to an apparatus, wherein the list of common blocking resources and the list of distinct blocking resources include blocking resources that impact snappiness of the page.

In some aspects, the techniques described herein relate to an apparatus, wherein page-types include at least one of a product or a collection.

In some aspects, the techniques described herein relate to an apparatus, wherein the application causes the at least one processor to: compare using a regular expression, wherein the determination of the URL to page-type mapping is based at least in part on a comparison.

In some aspects, the techniques described herein relate to an apparatus, wherein the application further causes the at least one processor to: receive a request for a page URL; map the page URL to a page-type of the plurality of identified page-types; identifying common blocking resource sets for the page-type mapped to the page URL; identify additional blocking resource sets for the page URL; and combine the identified common blocking resource sets and the additional blocking resource sets to predict a set of blocking resources for the page URL.

In some aspects, the techniques described herein relate to an apparatus, wherein the application further causes the at least one processor to: generate hints from the set of identified common blocking resources and additional blocking resources, wherein the hints are used to at least one of prefetch or prioritize resources.

In some aspects, the techniques described herein relate to an apparatus, wherein the application further causes the at least one processor to; learn, via a trained machine learning model, to identify one or more page-types based on one or more corresponding HTML files of a page or a URL of a page; wherein the determination of the URL to page-type mapping is based at least in part on the trained machine learning model.

In some aspects, the techniques described herein relate to an apparatus, wherein the application causes the at least one processor to: obtain page URLs for the domain; group the page URLs into different page-types; identify URL patterns for each page-type; and store a list of patterns that identify page-types for the domain; wherein the at least one processor learns the URL to page-type mapping based at least in part on the list of patterns.

These and other systems, methods, objects, features, and advantages of the present disclosure will be apparent to those skilled in the art from the following detailed description of the preferred embodiment and the drawings.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE DRAWINGS

The disclosure and the following detailed description of certain embodiments thereof may be understood by reference to the following figures:

FIG. 1 depicts a timeline representation of events associated with a webpage and/or application;

FIG. 2 depicts aspects of a computer architecture for viewing webpages;

FIG. 3 depicts an example apparatus for accelerating webpage rendering;

FIG. 4 depicts a flow chart of different phases, in accordance with the current disclosure;

FIG. 5 depicts a flow chart showing aspects of the first phase, in accordance with the current disclosure;

FIG. 6 is a graphical diagram illustrating aspects of the process for learning page types during the first phase.

FIG. 7 depicts a flow chart showing aspects of the second phase, in accordance with the current disclosure;

FIG. 8 is a graphical diagram illustrating aspects of the process for per page type training during the second phase;

FIG. 9 depicts a flow chart showing aspects of the third phase, in accordance with the current disclosure;

FIG. 10 depicts a flow chart showing aspects of the fourth phase, in accordance with the current disclosure;

FIGS. 11-48 depict flow charts for methods in accordance with the current disclosure; and

FIGS. 49-57 depict aspects of an apparatus in accordance with the current disclosure.

### DETAILED DESCRIPTION

Disclosed herein are systems, methods, and/or apparatuses that enhance webpage performance by introducing novel and nonobvious techniques for improving the snappiness of a webpage and/or other types of computer applications. A webpage's performance and/or snappiness can often be hindered by the amount of time it takes to retrieve and/or load/render/display webpage resources. Embodiments of the techniques disclosed herein address the inefficiencies that occur when browsers or other applications fetch and/or process resources that may not be useful for the timely completion of events and/or tasks during rendering and/or loading of a webpage. Hints can be used to prioritize resources for loading and/or rendering. For example, hints may be used to designate a resource for preloading and/or early fetching such that a browser prioritizes fetching the designated resources. Hints may be used to create a more responsive and fluid user experience by reducing delays and/or the time to completion of tasks and/or events.

However, determining hints for every individual page in a website may be impractical. Webpages in large-scale domains, such as e-commerce websites, often consist of thousands or even millions of pages. Analyzing and generating hints for thousands or millions of pages would require significant computational resources, time, and memory, making such an approach inefficient and costly. This challenge is further compounded by the dynamic nature of e-commerce websites, where content frequently changes, and new pages are added regularly.

In many cases, webpages in a domain may share similar structures and layouts. For example, product pages within an e-commerce site typically follow a consistent template, featuring elements such as product images, descriptions, pricing information, and “add to cart” buttons. Similarly, collection pages often display grids or lists of products, accompanied by filtering and sorting options. Despite the vast number of pages, the underlying structure and resource requirements for these pages are often highly repetitive.

The similarity in page types provides an opportunity for optimization. Instead of treating each page as a unique entity requiring individual analysis, the shared characteristics across pages can be leveraged to identify common patterns and resource dependencies. For instance, the stylesheets, scripts, and layout elements used to render product pages are often identical or highly similar across the entire domain. By recognizing the structural similarities across pages, it becomes possible to group pages into distinct types and optimize resource loading for each type rather than for individual pages. This approach significantly reduces computational overhead while ensuring that the optimization strategies are broadly applicable across the domain.

The methods and systems disclosed herein introduce a scalable and efficient approach for optimizing webpage rendering through the identification and prioritization of blocking resources and the generation of hints. The approach leverages a multi-phase approach that may include sampling, machine learning, and/or real-time inference to reduce computational overhead while maintaining high accuracy. The methods and systems described herein include machine learning models and specialized algorithms that dynamically predict blocking resources for requested pages and generate hints to prioritize resource loading. The approach avoids the need for brute-force analysis of all pages, significantly reducing computational costs and memory usage. Additionally, the approach supports real-time inference, allowing hints to be generated dynamically as users request pages, thereby improving webpage responsiveness and enhancing user experience.

The current disclosure may refer and/or relate to one or more of the following terms.

“Snappiness”, as used herein, may be understood as a measure of the time elapsed between two or more events during the lifecycle of a webpage and/or application. In embodiments, events may include one or more network and connection events (e.g., DNS resolution, first byte received, request initiation), rendering and visual display events (e.g., first paint, above the fold rendering, first meaningful paint, etc.), interactivity and user engagement events (e.g., time to interactivity, first input delay, etc.), resource loading and execution events (e.g., DOM content loaded event, script execution completion, background resource loading completion, etc.), animation and visual effects events, and/or custom user-defined events.

In one example, snappiness may be the time interval between the initiation of a request for a webpage (e.g., when a user clicks a link and/or enters a URL) and the occurrence of a rendering event, such as First Contentful Paint (FCP), Largest Contentful Paint (LCP), Time to Interactive (TTI), and/or the like. By measuring the time between the initial request and these rendering events, developers can assess how efficiently a webpage or application delivers its content and functionality. In another example, snappiness may be measured as the time between the request for a page and the completion of all above-the-fold content rendering, providing a measure of time that the user can view and interact with important elements. Shorter intervals between events generally indicate higher snappiness, as users experience faster load times and reduced delays in interactivity.

In embodiments, snappiness can refer to the time required to complete a sequence of events during the lifecycle of a webpage or application interface. Rather than focusing on individual events, snappiness may encompass the overall duration needed for a series of events to occur.

Snappiness, as used herein, may also be measured based on user feedback, capturing the subjective perception of how responsive or usable a webpage or application is perceived by the user. In this context, the measurement of snappiness may be tied to events that reflect the user's experience, such as the moment a user indicates that they perceive the page as responsive, functional, or ready for interaction. For example, snappiness may be assessed through direct user input, such as surveys, ratings, and/or other forms of feedback where users specify whether they feel the page is responsive and/or usable. This feedback can be collected in real-time and/or retrospectively. In another example, snappiness may be inferred from implicit user behavior, such as the time at which users begin interacting with the page (e.g., clicking buttons, scrolling, or entering text). The interactions can serve as indicators that users perceive the page as ready for use. For instance, the time between a user's request for a webpage and their first interaction with the interface can provide a measure of snappiness.

In some cases, snappiness may be related to the timing of interactions or processing activities performed by another application, server, and/or device in relation to the content of a webpage or application. For example, snappiness may encompass the timing of interactions between the webpage and third-party services, such as payment gateways, authentication systems, or content delivery networks (CDNs).

Snappiness, as used herein, may be represented as a numerical value that quantifies the time of or between one or more events. The value can take different forms depending on the context and the method of measurement. In one example, snappiness may be expressed as the actual time elapsed, in units such as milliseconds or seconds, between specific events or sequences of events. In another example, snappiness may also be represented as a scaled or normalized number that is proportional or inversely proportional to the measured time. For instance, a lower numerical value on a predefined scale could correspond to shorter times and higher responsiveness, while a higher value could indicate longer times and reduced responsiveness. Scaling may be applied to make the measurement compare performance across different systems, devices, or network conditions. For example, a scale from one (1) to one hundred (100) could be used, where 1 represents extremely fast responsiveness and one hundred (100) represents significant delays. In another example, snappiness may be calculated as a composite metric that combines multiple time-based measurements into a single value. For example, it could aggregate the times for key events such as FCP, LCP, and TTI, weighted according to their impact on user experience.

Snappiness, as used herein, may also be represented as a non-numerical value, such as a relative descriptor, to provide a qualitative assessment related to the timing of the events. These descriptors can be used to categorize performance into different levels that can be understood and interpreted, particularly in contexts where precise numerical measurements may not be necessary or practical. For example, snappiness may be described using relative terms such as “low”, “medium”, or “high”, corresponding to different ranges of timing. In another example, snappiness may be described using relative terms such as “adequate” or “insufficient” that correspond to ranges of timing that are deemed acceptable or too long, respectively.

Snappiness can be determined through controlled laboratory setups or by analyzing real user data collected during actual usage. In a lab environment, developers can simulate various conditions, such as network speeds, device capabilities, and browser configurations, to measure snappiness under predefined scenarios. In some instances, snappiness can also be assessed using real user data, often referred to as Real User Monitoring (RUM).

As used herein, RUM data refers to feedback data that is obtained from the transaction of loading a webpage. RUM provides insights into the actual performance of a webpage as may be experienced by end users. In one example, RUM involves collecting performance metrics from users as they interact with a webpage or application in real-world conditions. This data is typically gathered using scripts embedded within the webpage, which monitor and record various performance indicators such as page load times, resource fetch timings, rendering milestones (e.g., First Contentful Paint, Largest Contentful Paint), user interaction delays, and errors encountered during the session. These scripts may transmit the collected data back to a central analytics server for further processing and analysis.

In some embodiments, RUM data may also be obtained from laboratory or synthetic testing of a webpage, even in the absence of actual user interaction. In such cases, automated browsers or testing frameworks simulate user behavior and page loads under controlled conditions, with performance metrics collected either through browser APIs or custom instrumentation scripts. This synthetic RUM data can complement real-world data, enabling a more comprehensive assessment of webpage performance across different devices, browsers, and network environments.

Non-limiting examples of RUM data include data concerning page load times, user paths, error rates, session duration, bounce rate, and/or any other related metric.

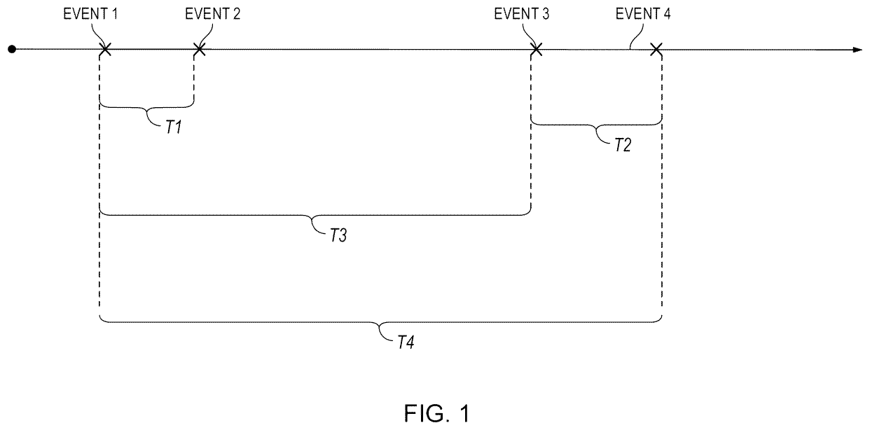

FIG. 1 illustrates a timeline representation of events associated with a webpage and/or application. As a page or application is processed (e.g., loaded, manipulated, and/or executed) one or more events or milestones may occur. The figure illustrates four (4) distinct events, labeled Event 1, Event 2, Event 3, and Event 4, which occur sequentially along the timeline. The intervals between these events are visually represented (T1, T2, T3, T4) and correspond to elapsed time between different sets of events.

For example, the time between Event 1 and Event 2 may correspond to the duration required for the browser to establish a network connection and receive the first byte of data. Similarly, the interval between Event 2 and Event 3 may represent the time taken to render the first visible content, such as text or images, while the time between Event 3 and Event 4 may reflect the completion of interactivity milestones, such as enabling user input or executing critical scripts.

In relation to FIG. 1, snappiness may be calculated based on the timing between one or more events that occur sequentially and/or are separated by other intervening events during the lifecycle of a webpage or application. In one example, snappiness may be based on an individual timing interval (e.g., T1 or T2). In another example, snappiness may be based on the cumulative timing of multiple sequential events such as T4. In yet another example, snappiness may be based on the duration of timing between multiple different time spans that may be disjointed (e.g., T1 and T2), overlapping (e.g., T4 and T1), and/or the like.

“Webpage resources”, “application resources”, and/or “resources”, as used herein, refer to visual (e.g., text, image, video, or the like) objects, audio objects, collections of one or more instructions (e.g., a page encoded in hypertext, a style sheet such as a cascading style sheet (CSS) for displaying and/or playing a webpage resource, a script file such as a JavaScript file, or the like), and/or a network service made available and/or provided by one device on a network to other devices upon request by one of the other devices. In embodiments, “webpage resources” may include the parts/elements that a webpage uses to function and/or display content. Resources can include any element or aspect of a webpage including HTML code, CSS code/files, scripts, images, fonts, multimedia, libraries, plugins, data files (e.g., JSON, XML), and the like. Resources may include parts that are requested and loaded by the browser when a user visits a webpage. Resources may also include parts that are executed on a client device, and, in some cases, they may include parts that are executed remotely.

“Event resources”, as disclosed herein, refer to resources that are needed to complete or facilitate the occurrence of a specific event during the lifecycle of a webpage or application. Event resources may include resources used by a webpage and/or application to display elements and/or to provide functionality that contribute to the purpose of the webpage (e.g., displaying a graphical picture of a good for purchase by a user and providing menu buttons to facilitate the purchase). The completion of an event (e.g., rendering above-the-fold content or enabling user input) often depends on the timely availability and processing of these resources.

Event resources may include blocking resources (e.g., resources that other webpage resources depend on and/or otherwise impact the rendering/display of the other webpage resources). Event resources may also include non-blocking resources (e.g., below-the-fold images, analytics, etc.). An event resource may be associated with multiple events and can be a blocking resource for more than one event. For example, a stylesheet may be required to render the layout of above-the-fold content during the initial loading phase and may also be necessary for styling interactive elements that appear later in the user experience. Similarly, a script may be needed for executing functionality tied to both the rendering of visible content and the activation of user input features.

A “blocking resource”, as used herein, may be an event resource whose absence or delayed availability may hinder or prevent the occurrence of a specific event during the lifecycle of a webpage or application. Blocking resources may be needed to facilitate the timely completion of events, such as rendering above-the-fold content, establishing interactivity, and/or executing scripts that contribute to functionality. For example, a blocking resource may include a stylesheet required for rendering the layout of visible content or a script necessary for enabling user input functionality. The absence or delay in loading such resources can result in incomplete or non-functional webpage elements, thereby obstructing the event's completion or occurrence. As such, blocking resources may impact a webpage's snappiness. As will be understood, blocking resources may include resources that a webpage has a fallback and/or alternative sequence of instructions to use in the event the resource is not available and/or delayed.

A “non-blocking resource”, as used herein, refers to an event resource that may not be strictly necessary for an event but may contribute to the webpage's purpose and/or user's overall experience with the webpage.

While certain embodiments are disclosed herein in the context of blocking resources, it is to be appreciated that such context is provided as a non-limiting example and that such embodiments are not limited to blocking resources. For example, such embodiments of the current disclosure may concern prioritized resources (e.g., resources associated with a prioritization), event resources (as disclosed herein), selected resources (e.g., resources that are selected/identified for pushing to a client device), and/or other types of resources that, while not necessarily blocking, may be likely to impact a webpage's rendering and/or loading speed and/or “snappiness”.

Webpages and applications may be composed of numerous resources, such as images, CSS, JavaScript files, fonts, and multimedia each of which can impact how and when specific parts of a page are displayed. In many instances, resources may include complex dependency chains. For example, JavaScript may rely on CSS for styling elements, or an image might be part of a script-driven animation. These dependencies may mean that removing or deprioritizing one resource can impact other elements or delay events altogether. In many instances, webpages may include dynamic content loading. Many webpages rely on JavaScript to load additional resources dynamically, often based on user interactions. Resources loaded after the initial render, such as content loaded via AJAX or API calls, can still affect the page's layout and functionality. In many instances, timing of events may depend on user-specific content. Event resources that are blocking resources may be dependent on various factors such as the user's device, screen size, or geographic location. For example, high-resolution images may be used on but non-essential on mobile.

A “hint,” as used herein, refers to an instruction and/or directive provided to a browser, application, and/or other computing system to optimize the management, loading, or rendering of resources associated with a webpage or application. Hints serve as guidance to prioritize, prefetch, preload, or otherwise manage resources in a manner that improves performance, reduces delays, and enhances the user experience. For example, a hint may indicate that a specific resource, such as a stylesheet or script, should be preloaded to ensure its availability during or before a rendering event. Alternatively, a hint may suggest deprioritizing non-essential resources, such as images located further down the page, to free up bandwidth and processing power for higher-priority tasks. Resource hints provide browsers and/or other applications with advance information about resources that will be needed, enabling more efficient loading strategies for webpages and/or associated resources.

Hints may help browsers make decisions about loading sequences, especially for resources that impact initial display and interactivity of a webpage. Through hints, key resources can be loaded promptly, reducing perceived wait times and enhancing page responsiveness.

Hints can take various forms, including metadata embedded in webpage code, scripts, or browser directives, and may be defined based on resource type (e.g., CSS, script, image, and/or the like) or event-specific requirements. Non-limiting examples of hints include: preconnects, preloads, prioritizations, prefetches, lazy-load directives, other types of actions, and/or any type of instruction structured to improve the snappiness of a webpage and/or other type of application. For example, hints may direct a webpage browser and/or other application to prioritize only the resources for specific events.

The terms “computer resources”, and/or “computing resources” may refer to the amount of memory and/or processing power available to a computer system to execute an application (e.g., a web browser, and/or to perform calculations). Non-limiting examples of the same include a number of processors, an amount of memory, and/or any other metric of hardware related to the computational power of a computing system (e.g., a number of floating-point operations per second (FLOPS) and/or any other metric of rating the performance and/or computational power of a computing system).

As used herein, a “parent” resource may form part of a resource hierarchy where a parent resource includes, among other elements, one or more instructions to fetch a “child” and/or “sub” resource from a specified device. Examples of a parent/sub resource include a webpage (e.g., written in a markup language such as hypertext markup language (HTML), extensible markup language (XML), or the like), a media manifest file or other file that references other media objects (e.g., a movie, a prerecorded television show), a service providing access to a streaming media object (e.g., a podcast, a live television broadcast, streaming music, or the like) that references other media objects, a service for transferring a specified data file that references other data objects, or the like. Any of the foregoing can also be a child/sub resource. Additional examples of child/sub resources include images, audio files, video files, style files such as cascaded style sheets (CSS), executable scripts such as JavaScript, and the like. Child/sub resources may further include sub elements of resources. For example, a resource such as a script file may include a plurality of scripts, and each of the plurality of scripts may be a sub-resource of the script resources.

A “webpage element”, as used herein, may refer to blocks that define the structure, content, and/or functionality of a webpage. Webpage elements may be code definitions and/or may be associated with resources. Non-limiting examples of webpage elements include HTML tags, wherein each tag can be an element.

A “webpage event”, as disclosed herein, may refer to specific moments and/or actions that occur during the lifecycle of a webpage. Webpage events may occur from when a page starts loading to when the webpage is fully interactive, to after it has been displayed, to after it has been left by the user.

“Significant events”, “snappi-events”, and/or “blocking events”, as used herein, may refer to a specific webpage event and/or a set of webpage events that are designated as having and/or relating to a meaningful and/or impactful completion of the loading, rendering, and/or other similar process for a webpage (e.g., the “snappiness” of a webpage). Significant and/or blocking events may be attributed as significant by a user and/or by computing system embodiments of the current disclosure (e.g., according to criteria and/or scoring methods). Significance may be attributed to various contexts, such as practical importance, percentage of load/render, time, etc. Examples of significant events include First Paint (FP) (the first point at which anything is rendered on the screen), First Contentful Paint (FCP) (the first piece of content is painted on the screen), Largest Contentful Paint (LCP) (the largest visible element is rendered), First Meaningful Paint (the primary content of the page is rendered), Time to Interactive (TTI) (the page becomes interactive, meaning it has finished rendering content and is responsive to user inputs), DOMContentLoaded (DCL) (the initial HTML document is fully loaded and parsed, but before other resources like stylesheets, images, and scripts are fully loaded), First Input Delay (FID) (the browser to respond to the first user interaction), and the like. In embodiments, significant events may include custom events that include a custom combination of one or more of loading, rendering, or interactivity milestones.

“Deprioritize”, as used herein, refers to reducing the importance of resources. For example, deprioritized resources may be removed as candidates for hints.

A “resource identifier”, as used herein, includes data that identifies the location of one or more resources. In some examples, a resource identifier may be part of a “Universal Resource Locator” (URL). For example, a URL may include a “host identifier” and a “resource identifier”, where the “host identifier” identifies a host server from which the resource is to be fetched, and the “resource identifier” identifies the resource itself with respect to other resources on the host server. In some examples, the resource identifier is a path to the resource on the host server.

“Loading”, as used herein with respect to a webpage, is to be understood broadly. In the context of webpages, “loading of a page” refers to one or more of fetching, rendering, placing in memory, or preparing all necessary resources so that the webpage is functional.

This includes not only downloading resources like HTML, CSS, JavaScript, images, and fonts but also rendering these resources within the browser to visually display the content, establish interactivity, and provide responsive behavior.

“Rendering”, as used herein with respect to a webpage, refers to the process of converting code (e.g., computer readable code such as HTML, CSS, JavaScript, etc., into viewable content).

“Transmitting”, as used herein with respect to a webpage, is to be understood broadly. In the context of webpages, “transmitting” refers to the process of delivering webpage content and/or resources to a client, either by sending them over a network or by providing them directly within a local server environment. When transmitting over a network, resources such as HTML, CSS, JavaScript, images, and multimedia files may be sent from a remote server to the client's browser through network protocols like HTTP or HTTPS. Alternatively, in a local server environment, transmitting may involve making these resources available directly from within the server's storage, bypassing the need for external network transfer. Transmitting as used herein may also refer to passing and/or sharing data and/or values between two or more circuits and/or other devices.

The term “substantially”, as used herein, means sufficient to work for the intended purpose. If used with respect to a numerical value or range, substantially means within ten percent.

As will be understood, embodiments of the current disclosure are not limited to the embodiments and applications disclosed herein or to the manner in which the embodiments and applications operate or are described herein. For example, while embodiments of the current disclosure are discussed in the context of improving the snappiness of a webpage as rendered and/or loaded by a web browser application, it is to be understood that the concepts and/or embodiments disclosed herein can be applied to other types of computer applications that fetch resources from non-local storage (e.g., smart phone applications, vehicle infotainment applications, table applications, desktop applications, spacecraft-based applications, etc.). As such, the term “webpage”, as used herein, should be understood to include embodiments of the current disclosure implemented by computer applications that fetch resources from non-local storage (e.g., smart phone applications, vehicle infotainment applications, tablet applications, desktop applications, spacecraft-based applications, etc.). For example, in a non-limiting embodiment, one or more aspects of a web browser and/or web browsing functionality may be included in an application (e.g., a vehicle infotainment system, a desktop web-based application, and/or the like). Accordingly, the term “webpage”, as used herein, may refer to a component of an application that uses resources from non-local storage, and the terms “browser”, “web browser”, “internet browser”, and/or “webpage browser”, as used herein, may refer to the application that includes the component.

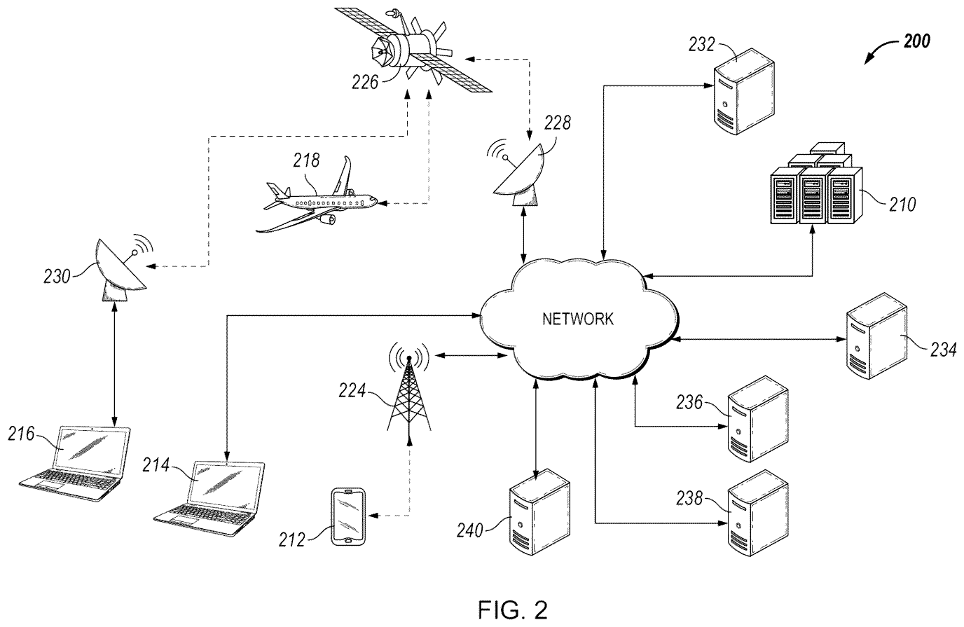

Accordingly, referring to FIG. 2, a computer architecture 200 for providing and viewing webpages and/or websites (e.g., multiple webpages under a single and/or related domain) includes one or more original hosting servers 210 and one or more client devices 212, 214, 216, and/or 218 that connect to the one or more original hosting servers 210 via a network 220. Each client device 212, 214, 216, 218 may include a web browser 222 structured to request and/or view one or more webpages hosted by the original hosting servers 210.

In embodiments, the computer architecture 200 may include one or more wireless portions (e.g., cellular, Bluetooth, and/or Wi-Fi connections 224, a satellite 226 with a corresponding uplink 228 and downlink 230) that form part of the network 220. In embodiments, one or more portions of the network 220 (e.g., the satellite 226, uplink 228, and/or downlink 230) may have high-latency and/or low bandwidth.

In embodiments, the browser 222 may be disposed on a client device 214, (e.g., a laptop, desktop, etc.) connected to the network 220 via a landline (e.g., a coaxial, fiber, telephone line, etc.). The browser 222 may be disposed on a mobile client device 212, (e.g., a smartphone, tablet, etc.) connected to the network 220 via a cellular connection 224. The browser 222 may be disposed on a client device 216 (e.g., a laptop, desktop, etc.) connected to the network 220 via a satellite downlink 230 in a remote location (e.g., Christmas Island). As will be understood, client device 218 may represent a plurality of client devices located on a vehicle, (e.g., a plane, ship, spaceship, car, truck, motorbike, bicycle, etc.) that has a satellite downlink through which the client devices connect to the network 220.

The computer architecture 200 may include one or more intermediate servers such as one or more resource servers 232, one or more content delivery network (CDN) servers 234 and 236, one or more hinting servers 238, and/or other types of servers 240 and/or computing devices that assist and/or improve the ability of the client devices 212, 214, 216, 218 to view the one or more webpages and/or improve the ability of the one or more original hosting servers 210 (also referred to herein as origin servers and/or origins) to serve/provide the one or more webpages (e.g., one or more hint discovery and/or optimization/tuning servers). As will be understood, the one or more original hosting servers 210 and/or the one or more intermediate servers 232, 234, 236, 238 and/or 240 may be non-virtualized servers (also known as physical and/or bare-metal servers) and/or virtualized servers that may be hosted by a single datacenter/server farm disposed at a single physical site, and/or hosted via a distributed cloud-based architecture disposed across multiple physical sites. As such, the one or more original hosting servers 210 and/or the one or more intermediate servers 232, 234, 236, 238 and/or 240 may be physically separated (e.g., running on different physical machines) and/or logically separated (e.g., running in different logical portions (e.g., virtual machines, containers, etc.) of a common physical computing architecture).

In embodiments, the one or more original hosting servers 210 include the root directory which, in turn, may include the index file(s) for the one or more webpages (e.g., index.php, index.html, default.html, any other file types containing a markup language, and/or any data file that defined and/or guides the layout of a webpage). As used herein, the terms “root” and/or “root file” may refer to one or more of the files in the root directory that are served by a web hosting server. In embodiments, a webpage served by a webserver 210 may be a standalone page (e.g., a single webpage site). In embodiments, a webpage served by a webserver 210 may form part of a multi-page site (e.g., an ecommerce site). In embodiments, the multi-page site may include a site that includes thousands or even millions of pages. The pages may be associated with one or more domains.

The one or more resource servers 232 may store one or more resources for the one or more webpages served by the one or more original hosting servers 210. As disclosed herein, the stored resources may include image files, web applications (e.g., Java applets), sound, video, and/or other types of media files, and/or any other type of webpage resource disclosed herein. The one or more resource servers 232 may be, in whole or in part, co-located with the one or more original hosting servers 210 and/or located apart from the one or more original hosting servers 210. For example, in embodiments, the one or more resource servers 232 may form part of a backend architecture hosted and/or owned by a web hosting service company, and/or hosted and/or owned by a third-party distinct from one or more parties operating and/or owning the one or more original hosting servers 210 and/or their hosted webpages and/or websites.

The one or more content delivery network (CDN) servers 234 and 236 may function as a cache for the webpage resources hosted by the one or more resource servers 232. In embodiments, one of the CDN servers (e.g., server 236) may have a faster network connection to a client device (e.g., mobile device 212), than to the one or more resource servers 232 so that the browser on the client device 212 can access the resources cached on the server 236 faster than would be possible by directly accessing the resources at the one or more resource servers 232. In embodiments, the CDN servers 234 and 236 may have improved connection speeds to a client device 212, 214, 216, and/or 218 over the one or more resource servers 232 due to being physically closer to the one or more client device 212, 214, 216, and/or 218, and/or due to using network paths and/or computing systems having greater capacities (e.g., more bandwidth, memory, and/or processing power) as compared to the network paths and/or computing systems utilized when the one or more client device 212, 214, 216, and/or 218 directly accesses resources at the one or more resource servers 232.

The one or more hinting servers 238 may generate and/or store hints for the one or more webpages and/or websites hosted by the one or more original hosting servers 210, which can be accessed by the web browsers of the client devices 212, 214, 216, 218. For example, the one or more hinting servers 238 may provide/host a hinting service that communicates hints to a web browser. The hinting service may include origin components configured to generate, manage, and store hints. The hinting service may include edge components deployed as distributed worker servers. These edge components may deliver hints to user devices 212, 214, 216, 218 with minimal latency, accessing the nearest data center for each user's location. The edge components may be edge servers distributed geographically. By hosting edge components close to end users, the hinting service may serve optimization hints in real time, adapting to specific conditions like network speed and device capabilities. By utilizing a cloud-based, multi-layered architecture, embodiments of the hinting service may combine centralized hint generation with distributed, low-latency hint delivery, which, in turn, may optimize performance across diverse geographic and/or technical environments.

In the case of large websites or domains with a very large number of different webpages, the hinting server 238 may, in some embodiments, store a mapping of each page URL and its corresponding list of hints. However, maintaining a one-to-one mapping between every individual page and its hints can quickly become impractical as the number of pages grows, leading to excessive storage requirements, increased management complexity, and slower retrieval times. This challenge is particularly acute for e-commerce sites and other content-rich domains where new pages are frequently added and existing pages are regularly updated.

The methods and systems described herein provide for an improved arrangement in which hints are associated with a page-type of a domain. By categorizing pages into types based on structural similarities (e.g., such as product pages, collection pages, informational pages, etc.) the system can generate and store a set of common hints for each page type. When a user requests a specific page, the hinting server 238 can quickly determine the page type, retrieve the associated common hints, and, if available, supplement them with any unique hints derived from RUM data or previously observed page-specific characteristics. The page-type-based approach reduces the storage and computational overhead required to manage hints across large domains. It also enables rapid adaptation to change in site structure, as updates to hints for a given page type automatically benefit other pages of that type.

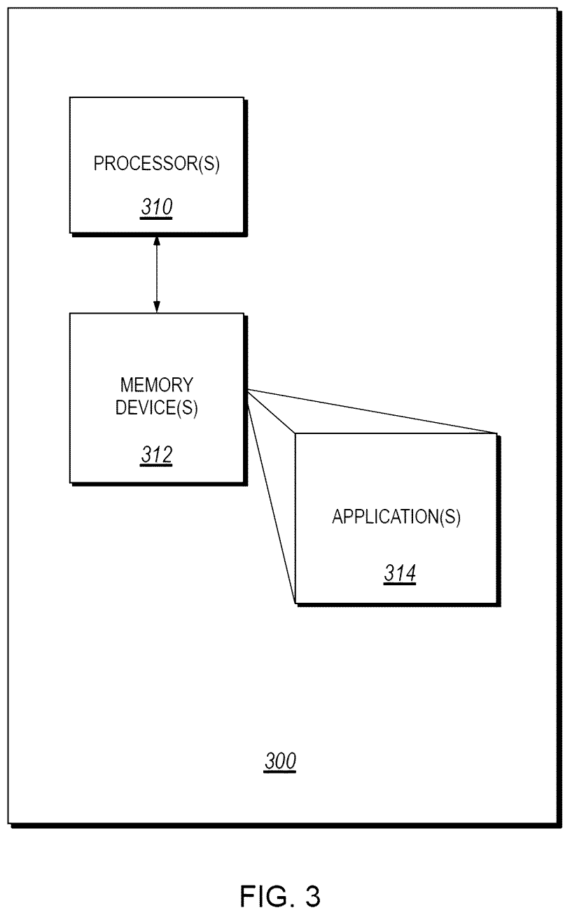

FIG. 3 depicts an apparatus 300 for performing one or more of the methods disclosed herein, in accordance with embodiments of the current disclosure. Embodiments of the apparatus 300 may be implemented, in whole or in part, by and/or otherwise form part of the one or more original hosting servers 210, the one or more client devices 212, 214, 216, 218, the one or more resource servers 232, the one or more CDN servers 234, 236, the one or more hinting servers 238, the one or more other intermediate servers 240, and/or any other computing device disclosed herein. The apparatus 300 includes one or more processors 310 and/or one or more memory devices 312. The one or more memory devices 312 may store an application 314 that, when loaded into the one or more processors 310, causes the one or more processors 310 to perform one or more portions of the methods disclosed herein. While the one or more processors 310, one or more memory devices 312, and/or application 314 are shown as included in an apparatus 300, in embodiments, the one or more processors 310, one or more memory devices 312, and/or application 314 may form a system for rendering webpages, as disclosed herein.

Embodiments described herein relate to scalable methods and systems that utilize structural similarities across pages within a domain. These methods and systems include categorizing URLs into distinct page types and sampling a representative subset from each type. By analyzing these samples, common blocking resources shared across pages of a type can be identified, along with patterns for locating resources unique to individual pages. When a user requests a previously unanalyzed page, the URL is mapped to its corresponding page type, the common blocking resources for that type are retrieved, and the unique resources specific to the requested page are identified and combined to predict the set of blocking resources. This predictive approach facilitates the generation of optimized rendering hints for pages within the domain, including those not explicitly analyzed beforehand.

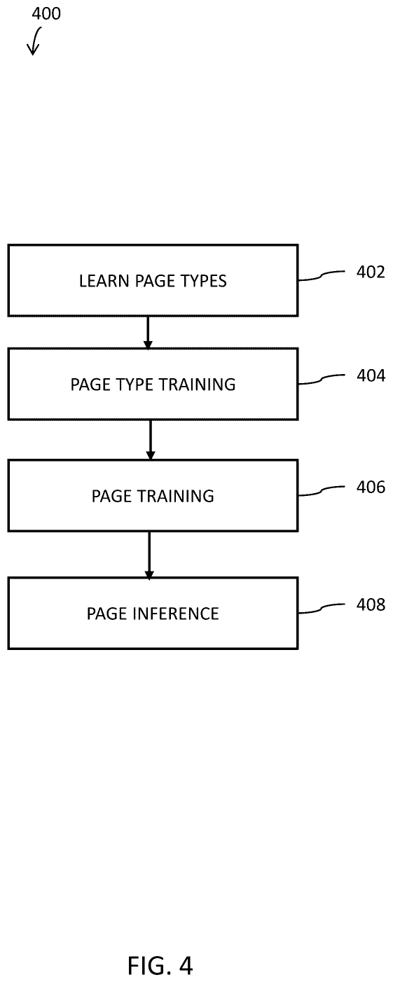

The systems and methods disclosed herein include a multi-phase approach to efficiently analyze, categorize, and optimize resource loading for large-scale domains. FIG. 4 shows one example of different phases 400 that may be employed. While the process is described in four distinct phases for clarity and ease of understanding, it should be understood that this division is exemplary and not limiting. The phases may be combined, subdivided, or reorganized in various ways without departing from the spirit and scope of the invention. Alternative embodiments may employ different numbers of phases or stages or may structure the process as a continuous workflow rather than discrete phases. The four phases described herein provide a logical framework for understanding the components of the methods and systems. In one example, in some implementations, phases 402 and 404 may be combined or effectively considered to be one phase.

The phases describe a process from initial domain analysis to real-time hint generation for page requests. However, in some embodiments, the process may perform certain operations in parallel or iterate through the phases in a cyclical manner for continuous improvement.

The first phase 402 may include learning page types. The phase 402 may include categorizing URLs into distinct page types based on their structural similarities. The process includes analyzing URL patterns to identify consistent elements that define page types, such as “product pages,” “collection pages,” or “blog pages.” Techniques such as regular expressions, direct lookup, tokenization, or machine learning models may be employed to group pages into types. Once categorized, the mappings of URLs to page types are stored for future reference.

The second phase 404 may include page-type training. In the second phase 404, a representative subset of pages may be sampled for each identified page type. These sampled pages are analyzed to identify common blocking resources shared across all pages of the type, as well as distinct resources unique to individual pages. RUM data is leveraged to refine the identification of these resources, ensuring accuracy and relevance. The results, including the common and distinct resource sets, are stored in a database, enabling insights gained from the sampled pages to be generalized across all pages of the same type.

The third phase 406 may include page training. The third phase focuses on refining the optimization for individual pages within each page type. Using RUM feedback, the distinct blocking resources for each page may be dynamically identified and refined. The phase 406 may include analyzing the specific resources required for rendering unique elements of the page, such as product-specific images or dynamic content. The refined resource sets may be stored, keyed by the page URL, to enable efficient retrieval and application during real-time optimization.

The fourth phase 408 may include page inference. The fourth phase 408 may be configured to provide inference and optimization as user requests arrive. When a page URL is requested, the URL may be mapped to its corresponding page type using the stored mappings from the first phase 402. The common blocking resource sets for the page type are retrieved, and the unique blocking resource sets for the specific page URL are identified. These sets are combined to predict the complete set of blocking resources required for rendering the page. Optimization hints may be dynamically generated based on the prediction.

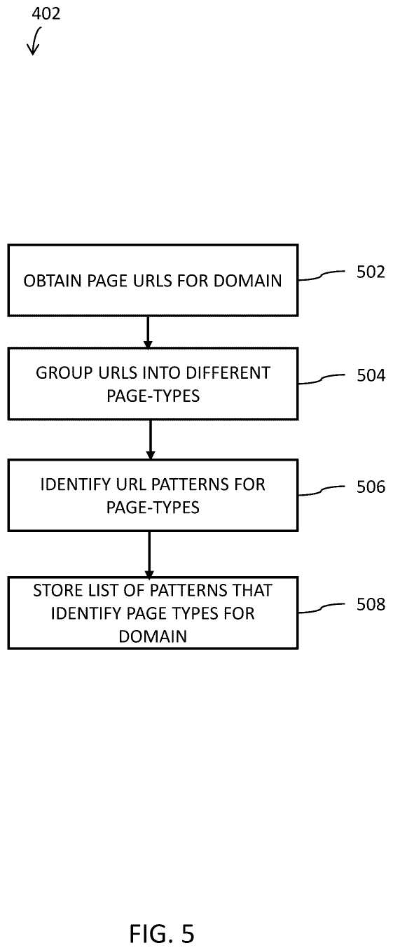

FIG. 5, depicts aspects of the first phase 402, which is directed to determining the different page types in a domain. In some cases, a domain may publish a list of page types that are used. The page types may correspond to well-defined page templates or definitions. However, in many cases if a predefined list of page types is not available, determining the page types for a domain may require sampling and analysis. When a predetermined list of page types is not available, the first phase 402 may include first obtaining a comprehensive list of URLs for the domain (502) that is later used to determine different page types in the domain. This list can be generated through various means, such as crawling the website, parsing the sitemap, or collecting URLs from RUM data as users visit the site. It is important to note that the URL collection and analysis process does not require capturing every single URL within a domain. In many cases, analyzing a representative subset of URLs can provide sufficient information to establish reliable page type classifications.

In one example, an adaptive sampling technique to efficiently learn page types can be used. Adaptive sampling may include analyzing a small initial set of URLs, such as those found in the site's main navigation or sitemap. Capturing of additional URLs may continue until the rate of discovering new patterns or page types falls below a predetermined threshold, at which point it may be determined that a sufficient representation of the domain's structure and page types has been obtained. In another example, statistical methods may be employed to estimate the confidence level based on the sample size and observed variability. In many instances, such as in an e-commerce site with millions of product pages, analyzing a few thousand strategically sampled URLs may be sufficient.

Once the list of URLs is available, the URLs and/or resources associated with the URLs (e.g., the webpages and/or the child resources of each page) can be analyzed to identify patterns that indicate structural similarity, such that the URLs can be grouped into different page types 504. To group URLs into page types, several techniques may be employed. In one example, regular expressions can be used to match recurring patterns in the URLs, allowing for the automatic classification of pages. In another example, tokenization and string analysis may be used to break down URLs into their constituent parts and identify invariant segments that define a page type. Alternatively, machine learning models can be trained to recognize and classify page types based on features extracted from the URLs and/or from the HTML structure of the pages themselves.

For example, in an e-commerce domain, one common page type may be “product” pages, which display detailed information about individual products available for purchase. These product pages typically share a consistent structure and layout but are differentiated by the specific product data they present. In many cases, the URLs associated with product pages contain identifiable patterns, such as the inclusion of the word “product,” an abbreviation like “pd,” or other standardized tokens within the URL path or query parameters. URL analysis can be employed to systematically detect these patterns by searching for predefined words, character sequences, or string formats that are indicative of a particular page type. For instance, a URL such as www.example.com/product/12345 or www.example.com/pd/67890 can be recognized as belonging to the product page type based on the presence of these keywords or structures.

In some cases, URL analysis alone may not provide sufficient information for accurate page type classification. In these instances, the approach described herein can extend its analysis to include examination of page resources (e.g., the HTML content, templates, images, files, etc. associated with the page). In one example, the described approach can fetch and parse the HTML of sampled pages, analyzing the document structure, tag hierarchy, and elements to identify common patterns associated with different page types. In another example, natural language processing and text classification techniques can be applied to the textual content of pages to identify common themes or purposes that indicate specific page types.

In certain embodiments, RUM data may include explicit page-type classification information provided by analytics systems, content management systems, or embedded metadata within the webpage. This page-type information may be directly extracted from the RUM data stream, eliminating the need for URL pattern analysis or machine learning classification. For example, RUM data may include fields such as ‘pageType: product’ or ‘category: collection’ that explicitly identify the page classification. When such explicit page-type information is available in RUM data, the system may bypass the URL pattern analysis phase and directly utilize the provided classifications.

Once the different page types have been identified, each page's URL can be associated with its corresponding page type. The URLs can then be grouped according to their assigned page type 504, enabling efficient organization and further analysis based on these classifications. For example, the two example URLs www.example.com/product/12345 and www.example.com/pd/67890 may both be grouped as relating to a page type of “products”.

After the grouping, a mapping may be created that associates each URL in the domain with its corresponding page type. In embodiments, mapping may include analysis of the URLs within each group to identify common patterns and structures 506. In embodiments, mapping may include one or more URL decomposition, frequency analysis, pattern extraction, regular expression generation, machine learning training, and the like.

In some embodiments, the URL to page-type mapping may comprise a direct lookup table that associates individual page URLs with their corresponding page types without requiring pattern analysis or machine learning classification. This direct mapping approach may be particularly advantageous in scenarios where the set of page types is known in advance, such as in content management systems or e-commerce platforms with well-defined templates. It may also be preferred in environments where computational efficiency and rapid lookup are prioritized over the discovery of new patterns or the flexibility to adapt to evolving site structures. The direct mapping may be implemented by storing each page URL as a key in a database or other data storage system, with the associated page type as the corresponding value. This key-value pair structure allows for retrieval of the page type for a given URL. The lookup table can be populated manually, generated from existing site metadata, or exported from a system that already maintains page-type associations. Additionally, the direct mapping can be periodically updated to reflect changes in the site's inventory, such as the addition of new pages or the reclassification of existing ones.

The mapping of URLs and/or patterns may be stored 508 (e.g., in a database, as a file, etc.) and used for rapid determination of a page type for a URL or new URLs from the domain. For example, in relation to the example “products” groups, a mapping in the domain main include a rule (e.g., a regular expression) that indicates that any URL with the words product or pd relate to the “products” page type.

In embodiments, URL and page type groupings may be used to train a model to identify page types based on the URL and/or page resources associated with the URL. The model may utilize various machine learning techniques, including but not limited to decision trees, support vector machines, or neural network-based models. For example, a neural network may be trained on features extracted from the URL structure, resource paths, or metadata associated with each page, enabling the model to accurately classify new or previously unseen URLs into the appropriate page types.

The kinds of page types identified within a domain can vary depending on the nature and purpose of the website. Some common examples of page types often encountered across various domains include product pages, blog post pages, search result pages, checkout pages, help pages, shopping cart pages, legal pages, gallery pages, and the like. In many cases, even in expansive domains comprising millions of individual pages, the number of distinct page types is often orders of magnitude smaller. For instance, an e-commerce website with over a million product pages, thousands of category listings, and numerous other page varieties may, in some cases, be effectively described using 10-20 distinct page types, such as Product Detail, Category Listing, Blog Article, Informational, Home, Search Results, User Account, and Checkout Process pages.

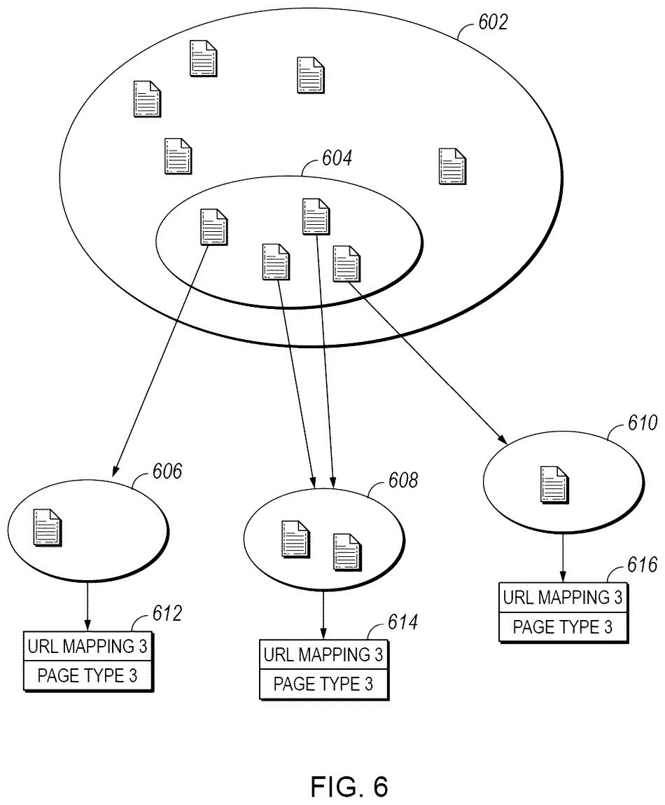

FIG. 6 is a graphical diagram illustrating aspects of the process for learning page types during the first phase. In certain embodiments, a domain 602 may comprise a large number of webpages, making exhaustive analysis impractical. Accordingly, the process may include sampling a subset of pages 604 from the domain. The sampled subset 604 is then analyzed to determine a plurality of distinct page types present within the domain. Upon identifying the page types, the sampled pages 604 are grouped according to their determined page type. For each group, the URLs of the constituent pages (groups 606, 608, and 610) are further analyzed to identify patterns or features within the URLs that can reliably indicate the page type. These features may include specific path segments, tokens, query parameters, or other structural elements that are consistent across the URLs of the same type. The URL features identified for each group are then saved, forming a set of rules or patterns that can be used to classify additional URLs encountered in the domain. The resulting mappings (such as 612, 614, and 616) are stored in a data storage component.

In some embodiments, a domain may undergo periodic remapping to ensure continued accuracy and adaptability as the structure and content of the domain evolve over time. As new pages are added, existing pages are modified, or URL patterns change, the initial mappings of URLs to page types may become outdated or less effective. To address this, the process may include scheduled or event-driven reanalysis of the domain's URLs, during which a new or updated subset of pages is sampled and analyzed. The process may then update the grouping of pages, refine the identification of page types, and regenerate the URL patterns or classification rules as needed.

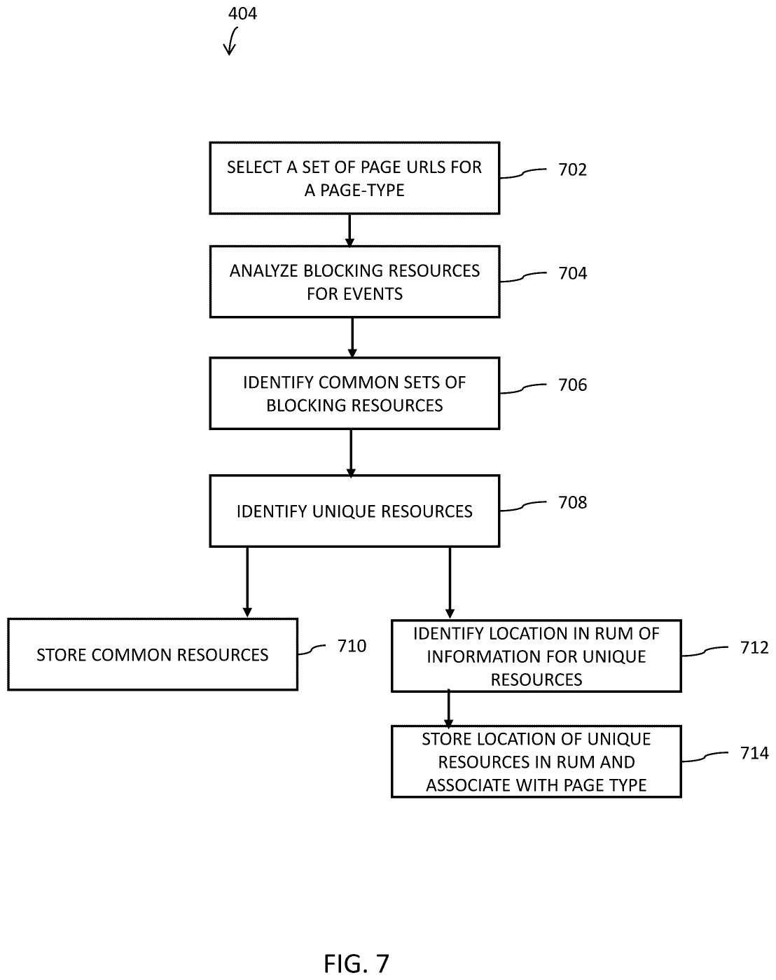

FIG. 7 depicts aspects of the second phase 404 related to per page type training. The second phase 404 may leverage the structural groupings established in the first phase 402. The second phase 404 may be used to identify, for each page type, the common blocking resources that are shared across pages of that type. In some embodiments, the second phase 404 may also include identifying unique blocking resources that are distinct for individual pages within the type. The steps of the process of the second phase 404 may be repeated for each page type identified in the domain.

The second phase 404 may include selecting a representative subset of pages (e.g., page URLs) from a page type 702. The representative subset may be selected from groups of page-types identified by the process in first phase 402 or any other suitable process that provides a grouping of URLs based on page type. The subset size may be determined based on statistical sampling methods, site analytics, or practical considerations such as computational resources. For example, in a domain with thousands of product pages, a sample of several dozen may be sufficient to capture the structural and resource-loading characteristics of a page type.

In one embodiment, each sampled page may be analyzed to determine its set of blocking resources for one or more events associated with the page 704. The analysis may be performed using automated tools, such as browser instrumentation, synthetic testing, or by leveraging RUM data. In one example, blocking resources for an event associated with a page may be identified using the techniques described in PCT Application No. PCT/US2024/054282 (published as WO 2025/097066), “SYSTEMS, METHODS, AND APPARATUSES FOR IDENTIFYING SIGNIFICANT WEBPAGE EVENTS AND TUNING WEB BROWSER HINTS,” filed Nov. 1, 2024, and/or PCT Application No. PCT/US2025/027270, “SYSTEMS, METHODS, AND APPARATUSES FOR IDENTIFYING BLOCKING RESOURCES OF CONTENT-RECTANGLE-BASED WEBPAGE EVENTS AND TUNING WEB BROWSER HINTS,” filed May 1, 2025, which are hereby incorporated herein by reference.

Once the blocking resources for one or more events for each sampled page are identified, the sets of blocking resources across the pages in the sample may be compared 706. The intersection of these sets yields the set of common blocking resources (e.g., those resources that are blocking for an event by every page of the page type). The common blocking resources often include shared stylesheets, scripts, and layout elements that define the structure and appearance of the page type. The lists of common blocking resources may be stored 710 (e.g., in a database, structured file, as a list, etc.).

In addition to the common blocking resources, the second phase 404 analysis may further include identifying unique blocking resources that are distinct for individual pages within the type 708. Unique blocking resources may include product-specific images, dynamic content, or other resources that vary from page to page. The process may involve pattern recognition, URL templating, or the use of RUM data to determine how these unique blocking resources can be reliably located or predicted for any page of the page type. The second phase 404 may include identifying the location in RUM data for the unique blocking resources 712. The location of the unique blocking resources in the RUM data may be stored and associated with the relevant page type 714.

In embodiments, identifying unique blocking resources for individual pages may involve training one or more models to extract the URLs of blocking resources that are specific to each page. The models may utilize a variety of machine learning techniques, such as supervised learning with labeled RUM data, to learn patterns and features that identify unique blocking resources. The models may analyze resource timing data, DOM structure, URL patterns, and other contextual information from RUM data to infer which resources are blocking resources. During the training process, the models may be exposed to RUM data for each page type. After the training, the models may be used for the extraction process. Extraction may be applied in real time to new page requests, automatically extracting the URLs of unique blocking resources.

In one example, the identification of unique blocking resources for individual pages may include LCP image extraction. As used herein, LCP image extraction refers to the process of identifying the image resource on a webpage that is responsible or associated with the Largest Contentful Paint event. In many cases, the LCP element is a prominent image, such as a product photo or a featured banner and may be a blocking resource that is unique to the page. To extract the LCP image, RUM data or browser performance APIs may be used to capture information about rendering events during a page load. The captured data may include the timing of the LCP event, the DOM element type (e.g., IMG), and the URL of the image resource that triggered the LCP. In some embodiments, the RUM data from various pages may be used to train a model to extract or identify the LCP element URL based on a pattern of the URL, location in the HTML, and the like.

In another example, the identification of unique blocking resources for individual pages may include resource timing waterfall analysis. During the training phase, it may be observed that some characteristics of the resources from the waterfall analysis consistently correspond to one or more elements associated with blocking resources. In one example, the third-largest image by file size in the resource timing waterfall may consistently correspond to the product gallery thumbnail strip on product pages. In embodiments, RUM data may be captured and may include the characteristics of the loaded resources (e.g., timing, file sizes, etc.) which may be used to identify specific resources. During loading of a page, the RUM data may be collected and the identification of the blocking resources may include analyzing timing and characteristics of the data. In one example, identification may include sorting image resources by their transfer size and then selecting the third-largest image resource.

In another example, the identification of unique blocking resources for individual pages may include critical path CSS pattern recognition. RUM data collected may include resource timing entries for resources such as CSS files loaded during the page visit, as well as the resource URLs. During the training phase, RUM data may be analyzed to determine that blocking resources (e.g., CSS files) follow a URL pattern (e.g., /css/product-{productId}.css). The identified pattern may be captured with a regular expression (regex) that can be used to identify the blocking CSS files for the page type.

In another example, the identification of unique blocking resources for individual pages may include API response header analysis. During the training phase, it may be observed that API responses (e.g., Product API responses) include a custom header, such as X-Product-Assets, which contains a list of URLs or filenames corresponding to unique resources required for rendering the page. These resources may include images, charts, scripts, or other assets that are specific to the individual product being displayed. RUM data collected for training may include network timing data along with the complete set of response headers received during page loads. The extraction method may include parsing the response headers for the presence of the X-Product-Assets field and extracting the values it contains. For example, a response header might be:

X-Product-Assets: “hero-img.jpg,specs-chart.svg,360-view.js” By analyzing the contents of this header, the process can identify multiple product-specific assets (e.g., main product image, a specifications chart, a 360-degree view script) that are unique blocking resources for the page.

In another example, the identification of unique blocking resources for individual pages may include DOM content analysis. During the training phase, it may be observed that the first <img> tag's src attribute on product pages consistently points to the primary product image, which may be a blocking resource. RUM data collected for training may include DOM sampling data or initial HTML snippets, as well as the attributes and content of relevant elements. The extraction method may include parsing the DOM content to locate the first <img> tag and extracting the value of its src attribute. For example, the process may identify an element such as <img src=“https://cdn.shop.com/products/laptop-x1000-main.jpg”>. The prediction result is that the primary product image URL may then be extracted and identified as a unique blocking resource for the page.

In another example, the identification of unique blocking resources for individual pages may include the use of user timing marks. During the training phase, it may be observed that developers utilize the User Timing API to create performance marks that tag the loading of product-specific resources. These marks may be used as custom annotations within the browser's performance timeline, providing metadata about when certain critical resources are loaded. RUM data collected for training may include user timing entries, which capture the custom performance marks along with any associated metadata, such as resource URLs or descriptive details. The extraction method may include parsing these user timing entries to identify marks that indicate the loading of product-specific assets. For example, a developer might use a performance mark such as: performance.mark(‘product-asset-loaded’, {detail: ‘https://shop.com/assets/product-12345-chart.svg’}); By analyzing these performance marks, the process can extract the URLs of resources that have been explicitly tagged as important by the developer.

In another example, the identification of unique blocking resources for individual pages may include DOM-rooted initiator chain analysis. This approach may include tracking the complete chain of causality from specific DOM elements through JavaScript execution and API calls leading to the fetching of product-specific resources. By analyzing these initiator chains, it is possible to determine which DOM-initiated sequences result in the loading of critical, page-specific assets. For example, consider an image gallery on a product page. The process may begin with a DOM root element, such as a gallery container, which triggers a JavaScript file (e.g., gallery-init.js) to read a data-product-id attribute. This, in turn, may initiate an API call to an endpoint like /api/product/12345/images.json. The API response then triggers the fetching of specific image resources, such as https://cdn.shop.com/products/12345-angle1.jpg and https://cdn.shop.com/products/12345-angle2.jpg. RUM data may capture the initiator chain, from the original DOM attribute through JavaScript execution and API response, to the final resource URLs, and may be used to train a model to identify the chain.

A mapping of the unique blocking resource types (e.g., RUM location data, methodology of identifying unique blocking resources, regex patters, trained models) for each page type may be stored 714 (e.g., as a database, structured file, etc.). In some embodiments, the process may also store metadata or rules describing how to extract or infer unique resources for new pages, such as XPath expressions, URL patterns, or machine learning models trained on the sampled data. The set of blocking resources (both common and unique) may be identified for different events or rendering milestones for each page type. For example, in the context of a product page, common blocking resources for the “First Contentful Paint” (FCP) event might include shared CSS files and JavaScript libraries that are necessary to render the basic layout and navigation elements. Unique blocking resources for FCP could include the specific product image or a dynamically generated promotional banner that is unique to that product page. Similarly, for the “Largest Contentful Paint” (LCP) event, common blocking resources may consist of layout stylesheets and scripts required across all product pages, while unique blocking resources could be the main product image or a featured video specific to the individual product being displayed. For interactive events such as “Time to Interactive” (TTI), common blocking resources may include core JavaScript files that enable site-wide functionality, whereas unique blocking resources might involve product-specific scripts or widgets, such as a custom product configurator or a real-time inventory checker.

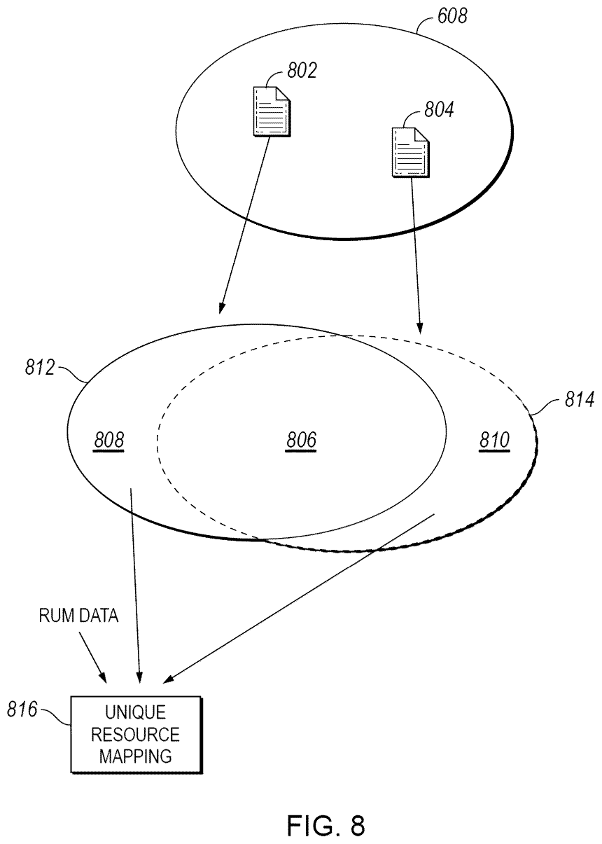

FIG. 8 is a graphical diagram illustrating aspects of the process for per page type training during the second phase. In this phase, pages such as 802 and 804, which are associated with a particular page type 608, are selected for detailed analysis. Each of these pages is examined to determine the set of blocking resources and/or hints that are associated with a specific event or rendering milestone of the page. For example, the process may identify a first set of blocking resources 812 for the first page 802 and a second set of blocking resources 814 for the second page 804. These sets are then compared to determine the intersection, which represents the common set of blocking resources 806 shared by all pages within the page type group. These common resources typically include elements such as shared stylesheets, scripts, or layout components that are essential for rendering any page of that type.

In addition to identifying the common set, the comparison process also determines the unique set of blocking resources for each individual page (808 for page 802 and 810 for page 804). These unique resources may include page-specific images, dynamic content, or other elements that are not shared across the group but are blocking for one or more significant events associated with the page (e.g., necessary for rendering the unique aspects of each page).

The second phase may also include a detailed analysis of the unique resources in conjunction with the respective RUM data to determine whether there is a consistent location, pattern, or method for identifying the unique blocking resources associated with a particular page type. This analysis may involve examining the RUM data across multiple sampled pages of the same type to detect recurring attributes, such as specific DOM element positions, resource URL structures, or timing patterns that reliably indicate the presence of unique resources 816. For example, as described herein, the approach may observe that the largest image loaded above the fold is always the product image for product pages, or that a particular script is only loaded for certain interactive features unique to individual pages. By identifying these consistent patterns or extraction rules, the process can automate the detection of unique blocking resources for any new page of the same type, even if that page has not been explicitly analyzed before.

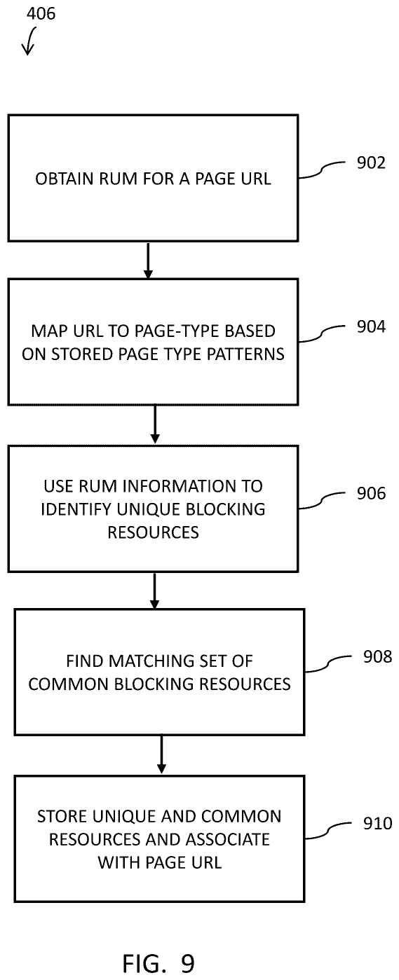

FIG. 9 depicts aspects of the third phase 406 directed to per page training. The third phase 406 may include refining and personalizing the optimization process for individual pages within each previously identified page type. Phase 406 may include obtaining real user monitoring RUM data or synthetic monitoring data for individual pages 902. For each page, a mapping of its URL to the appropriate page type 904 may be determined using the mapping and classification rules established in the first phase 402. With the page type identified, the set of common blocking resources associated with that type is retrieved (e.g., as determined in second phase 404).

Next, the RUM data for the specific page is analyzed, using the mapping determined in the second phase 404, to identify any additional blocking resources that are unique to that page 906. This may include product-specific images, dynamically generated scripts, or other resources that are not part of the common set. The process may involve extracting resource URLs from the RUM data, identifying the location of the largest image or the first interactive element, comparing these findings to the common set 908 to isolate the unique resources, and the like.

In some embodiments, algorithms or heuristics are applied to the RUM data to automate the identification of unique resources. For example, the approach may look for the Largest Contentful Paint (LCP) image URL, the first image above the fold, or the largest script file loaded during the initial render. These heuristics can be tailored to the specific structure and content of the page type.

Once the unique blocking resources for the page are identified, they may be combined with the common resources to form a set of blocking resources for that page. This set is then stored 910 and may be keyed by the page URL. Storing this information enables rapid retrieval and application of optimized hints for future visits to the same page.

The third phase may be executed the first time a page is requested by a user. Once the set of blocking resources for the page has been determined, this information is stored in a data storage component, keyed by the page URL. As a result, when the same page is requested in the future, either by the same user or by different users, the pre-determined set of blocking resources can be retrieved without needing to repeat the analysis. This enables immediate generation and delivery of optimized hints, such as prefetch or preload directives, in response to the request.

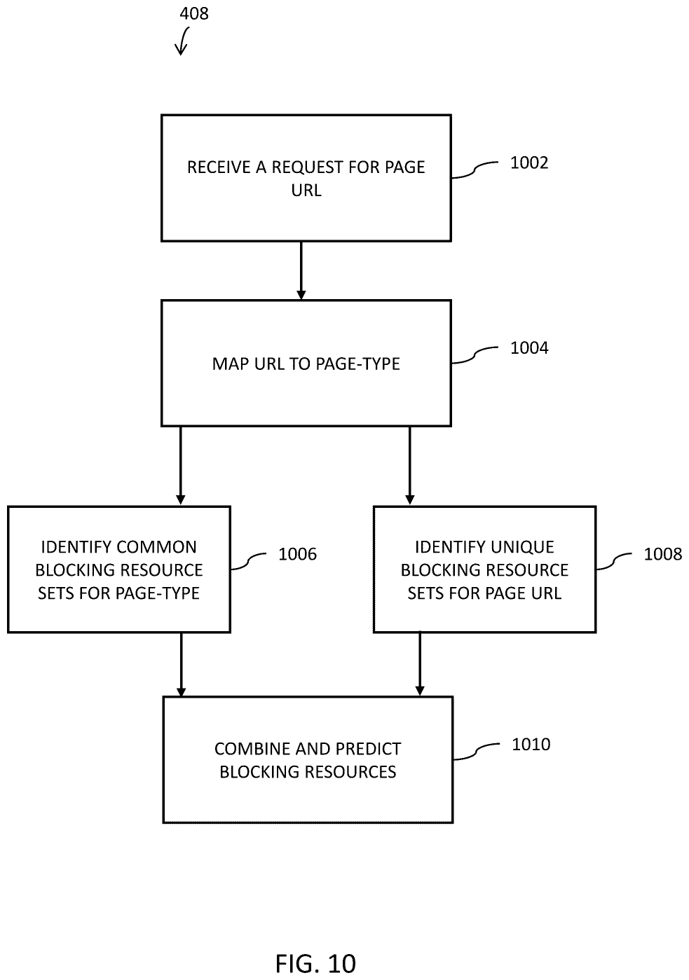

FIG. 10, depicts aspects of the fourth phase 408 directed to per page inference. The fourth phase 408 may include real-time inference and optimization to enable the delivery of optimized hints in response to requests for pages. The approach leverages the mappings, common resource sets, and unique resources identified in phases 402 through 406.

When a request for a page URL is received 1002, the process begins by mapping the requested URL to its corresponding page type 1004 using the stored URL-to-page-type mapping (e.g., mapping generated in Phase 402). This mapping allows the inference engine to quickly determine the structural context of the page, even if the specific URL has not been previously encountered. In certain embodiments, RUM data may include explicit page-type classification information and page-type information may be directly extracted from the RUM data stream.

Next, the process retrieves the set of common blocking resources associated with the identified page type 1006 (e.g., as established in Phase 404). These common resources typically include essential stylesheets, scripts, and layout elements that are required for rendering any page of that type.

The process also includes identifying unique blocking resources specific to the requested page URL 1008. If the page has been previously visited and per page training (e.g., third phase 406) has been performed, the unique resources for that URL are retrieved from storage. If the page is new or has not been analyzed before, the process applies inference algorithms—such as pattern matching, templated URL extraction, or heuristics based on RUM data from similar pages—to predict the likely unique resources. For example, the process may infer the location of a product-specific image or a dynamically generated script by analyzing the structure of the URL or by applying rules learned from other pages of the same type.

The identified common and unique blocking resources are then combined 1010 to form a predicted set of blocking resources for the requested page. Based on this combined set, the process may generate hints for the blocking resources, such as prefetch, preload, or prioritization directives, which are communicated to the browser or client device. These hints instruct the browser or client device to fetch and process the blocking resources early, reducing delays in rendering and improving the perceived snappiness of the page.

Hint generation may involve analyzing the type, criticality, and loading sequence of each resource to determine the effective optimization strategy. For example, resources that are needed for initial rendering (e.g., primary CSS files, JavaScript files, or primary images) may be assigned preload or prefetch directives. Other resources may be assigned prioritization hints, which adjust their loading order relative to less critical assets. Hint generation may further consider contextual factors, such as the user's device capabilities, network conditions, or historical performance data, to adjust the type and timing of hints. The generated hints may be communicated to the browser or client device using mechanisms, such as HTTP headers (e.g., Link: rel=preload), in-page <link> elements, or through integration with content delivery networks (CDNs) that support early hinting protocols. The generated hints may be used to instruct a browser or client device to fetch and process the blocking resources early, reducing delays in rendering and improving the perceived snappiness of the page.

In embodiments, Phase 408 may be deployed at a CDN or similar distributed infrastructure. By operating at the CDN edge, the approach can deliver hints with minimal latency, adapting to user location, network conditions, and device capabilities in real time.

The fourth phase 408 determines optimized hints for pages within the domain, including those that have not been explicitly analyzed or previously visited. By leveraging the structural similarities and predictive models developed in earlier phases, the process can generalize its optimization strategies, ensuring high performance and efficient resource usage across the entire site. As new RUM data is collected from user visits, the process can further refine its predictions and update its mappings, creating a continuous feedback loop that drives ongoing improvement.

Although the discussion herein focuses on determining blocking resources (both common and unique) for each page, the phases may also include determining hints. In embodiments, the process of determining blocking resources may be supplemented and/or replaced by determining hints in each phase of the methodology. For example, during per-type and per-page training instead of determining common blocking resources, common hints for a page type may be determined (e.g., by querying a hint server).

In embodiments, the effectiveness and accuracy of the prediction of blocking resources may be validated using a testing process. In one example, the testing process may include predicting blocking resources based on an URL (e.g., determining common and distinct blocking resources using the methods described herein) and comparing them against a known set of blocking resources for the webpage from the same URL. The known set may be established through manual analysis, synthetic testing, or ground truth data collected from controlled experiments. By comparing the predicted and actual sets, the method can identify any discrepancies, such as missing or extraneous resources. An accuracy metric, such as precision, recall, or F1 score, may then be calculated based on the comparison. The metric may be used as quantitative measure of the method's performance. If the calculated accuracy metric falls below a predetermined threshold, this may serve as an indicator that the current lists of blocking resources are no longer sufficiently accurate or effective for the given page or page type. In such cases, the system may be configured to automatically trigger a recalculation or retraining process. This process may involve re-sampling pages, collecting additional RUM data, or updating the machine learning models and pattern recognition algorithms used to identify blocking resources.

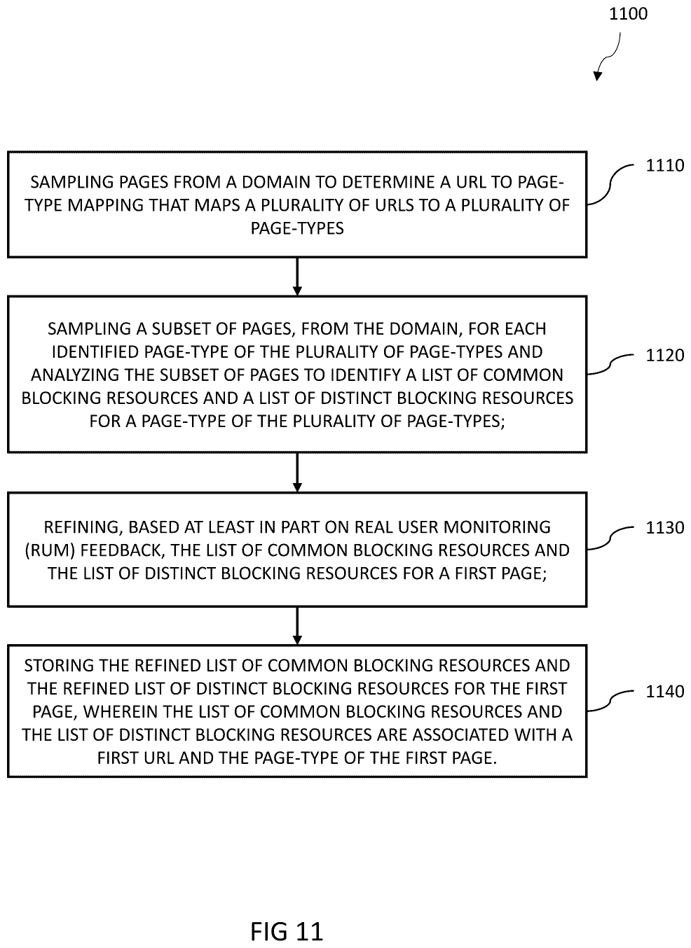

Referring to FIG. 11, a computer-implemented method 1100 may be provided. The method may include sampling pages from a domain to determine a URL to page-type mapping (1110). This step may include collecting a representative set of URLs from the domain, which may be accomplished by crawling the website, parsing sitemaps, or aggregating URLs from RUM data. The collected URLs are then analyzed to identify structural patterns, such as recurring path segments or tokens, that allow the URLs to be grouped into distinct page types (e.g., product pages, collection pages, blog pages). The result is a mapping that associates each URL with a specific page type.

Next, sampling a subset of pages from the domain for each identified page-type and analyzing the sampled subset to identify a list of common blocking resources and a list of distinct or unique blocking resources for each identified page-type (1120). In this step, a statistically significant subset of pages is selected for each page type. Each sampled page is analyzed (e.g., using browser instrumentation, synthetic testing, or RUM data) to determine which resources (such as CSS files, JavaScript files, or images) are required for rendering. The analysis identifies common blocking resources shared by all pages of the type, as well as distinct blocking resources unique to individual pages.

The method may further include, refining, based at least in part on RUM feedback, the list of common blocking resources and the list of distinct blocking resources for a page (1130). This step leverages RUM data collected from actual user interactions or synthetic monitoring to validate and update the lists of blocking resources. RUM feedback helps ensure that the identified resources are needed for rendering under real-world conditions and may reveal additional unique resources or changes in resource dependencies over time.

In embodiments, the method may further include storing the refined list of common blocking resources and the list of distinct blocking resources for the page, wherein the lists are associated with a URL and the page-type of the page (1140). The refined data is stored in a data storage component, such as a database, where each entry may be keyed by the page URL and its associated page type.

In some embodiments, identifying distinct blocking resources for individual pages may include analyzing locations within the DOM of the page to extract resource identifiers. The structure of the DOM may be used to identify specific elements (e.g., images, scripts, stylesheets) that are blocking resources for the page. For example, the method may parse the DOM to locate the first <img> tag or a particular script element, extracting the src or href attributes as resource identifiers.

In some embodiments, the URL to page-type mapping may be accomplished by receiving page-type information directly from RUM data. The RUM data collected during user interactions or synthetic testing may include explicit metadata or tags that indicate the page type, such as “product,” “collection,” or “blog.” By extracting this information from the RUM data, the URL can be associated with its corresponding page type without the need for complex pattern analysis or machine learning classification.

In further embodiments, the URL to page-type mapping may be determined by receiving page-type classification data from an external analytics system. For instance, a content management system, a CDN, or analytics platform may maintain a database of URLs and their associated page types. The classification data may be received from the external system and associated with the corresponding URLs.

Certain further aspects of the computer-implemented method 1100 are described following, any one or more of which may be present in certain embodiments.

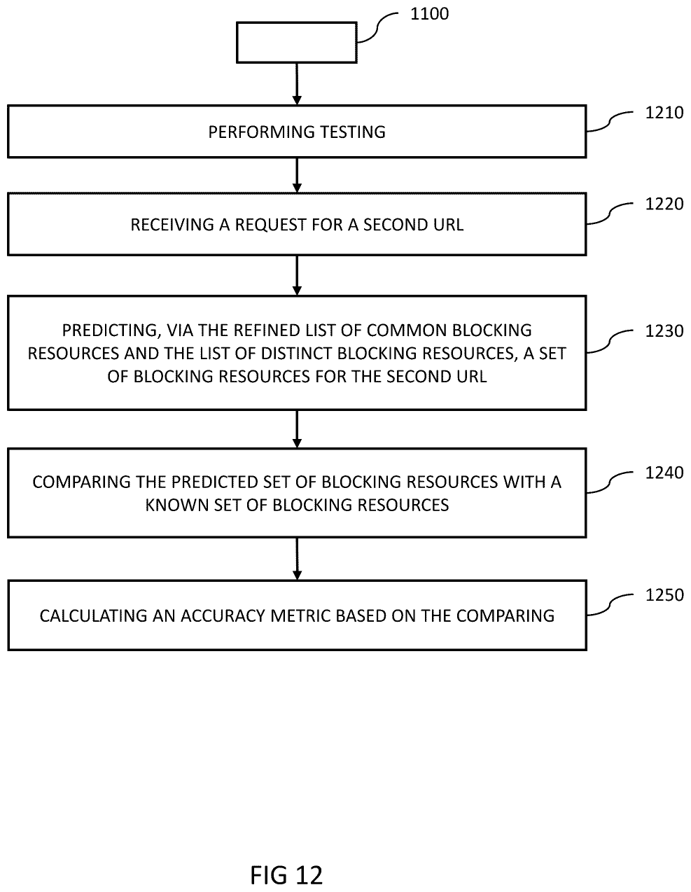

Referring to FIG. 12, the computer-implemented method 1100 may further include performing testing 1210 by: receiving a request for a first URL 1220; predicting, via the refined list of common blocking resources and the list of distinct blocking resources, a set of blocking resources for the URL 1230; comparing the predicted set of blocking resources with a known set of blocking resources 1240; and calculating an accuracy metric based on the comparing 1250.

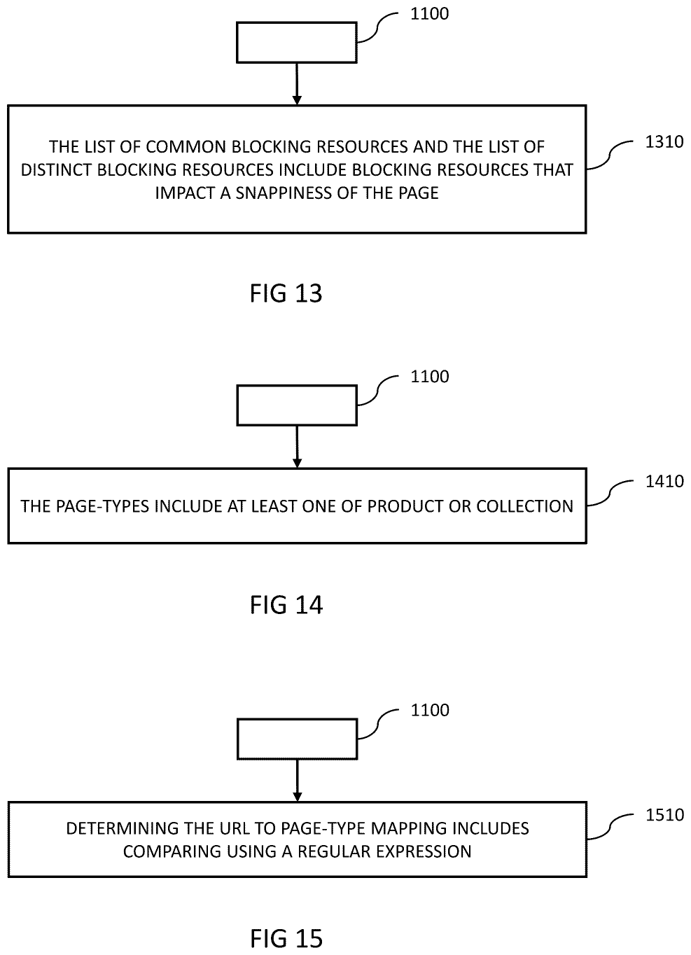

Referring to FIG. 13, the computer-implemented method 1100 may include, wherein the list of common blocking resources and the list of distinct blocking resources include blocking resources that impact a snappiness of the page 1310.

Referring to FIG. 14, the computer-implemented method 1100 may include, wherein the page-types include at least one of product or collection 1410.

Referring to FIG. 15, the computer-implemented method 1100 may include, wherein determining the URL to page-type mapping includes comparing using a regular expression 1510.

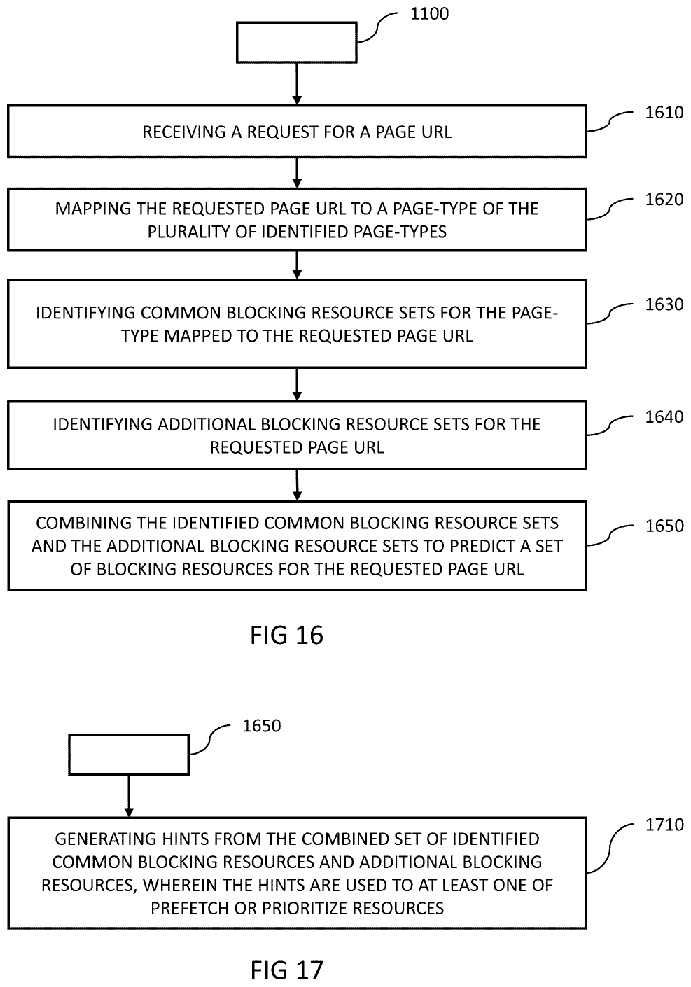

Referring to FIG. 16, the computer-implemented method 1100 may further include receiving a request for a page URL 1610; mapping the requested page URL to a page-type of the plurality of identified page-types 1620; identifying common blocking resource sets for the page-type mapped to the requested page URL 1630; identifying additional blocking resource sets for the requested page URL 1640; and combining the identified common blocking resource sets and the additional blocking resource sets to predict a set of blocking resources for the requested page URL 1650. Referring to FIG. 17, the method may further include generating hints from the combined set of identified common blocking resources and additional blocking resources, wherein the hints are used to at least one of prefetch or prioritize resources 1710.

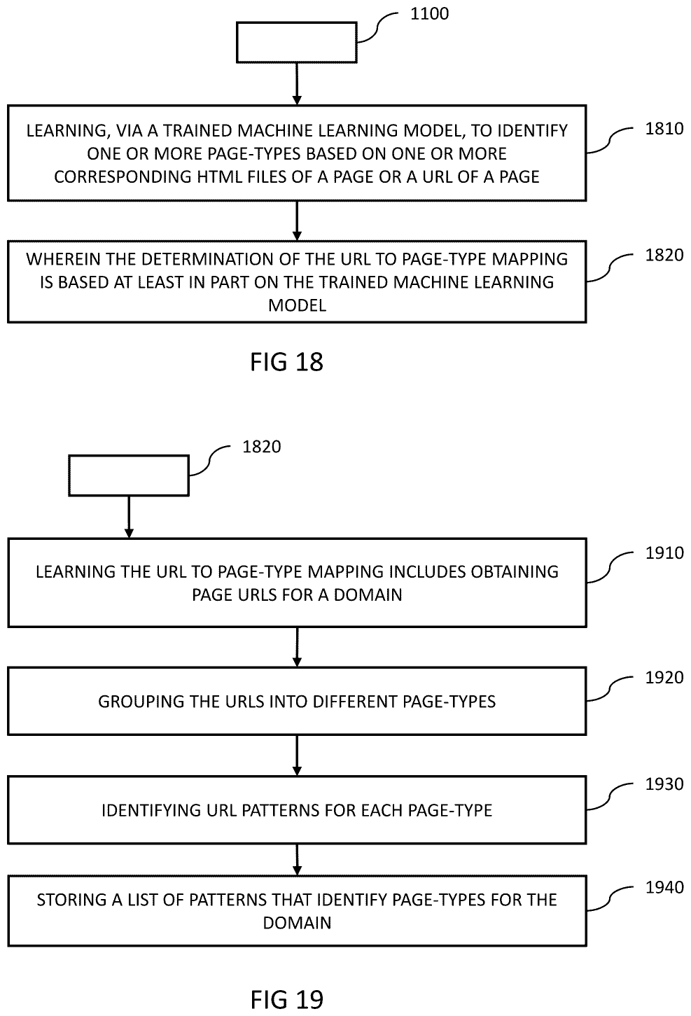

Referring to FIG. 18, the computer-implemented method 1100 may further include learning, via a trained machine learning model, to identify one or more page-types based on one or more corresponding HTML files of a page or a URL of a page 1810, wherein the determination of the URL to page-type mapping is based at least in part on the trained machine learning model 1820. Referring to FIG. 19, the method may include, wherein learning the URL to page-type mapping includes obtaining page URLs for a domain 1910; grouping the URLs into different page-types 1920; identifying URL patterns for each page-type 1930; and storing a list of patterns that identify page-types for the domain 1940.

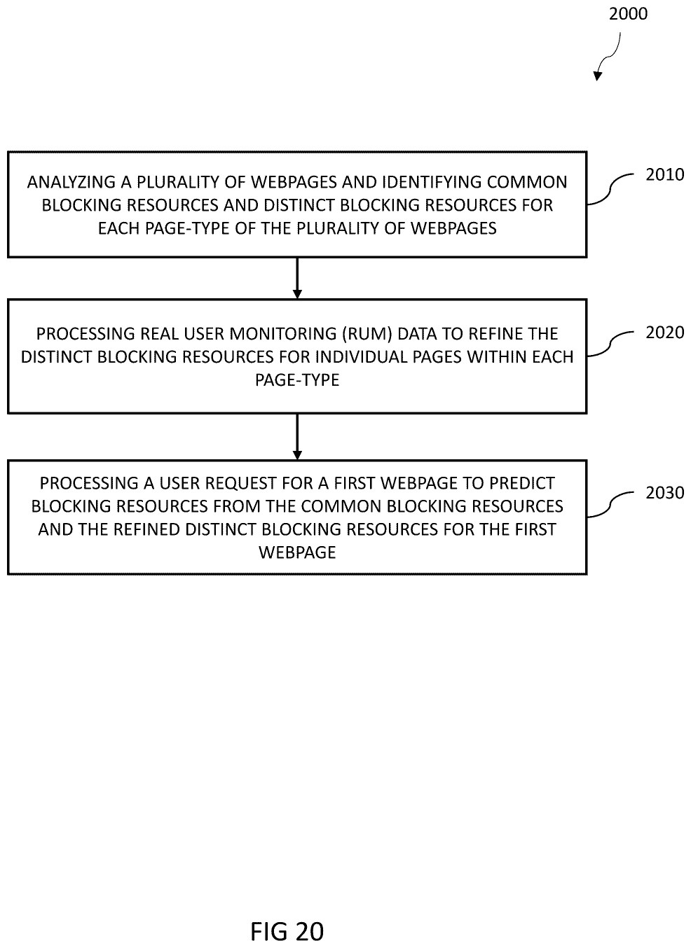

Referring to FIG. 20, a computer-implemented method 2000 may be provided. The method may include the step of analyzing a plurality of webpages and identifying common blocking resources and distinct blocking resources for each page-type of the plurality of webpages (2010). The method may further include processing RUM data to refine the identified distinct blocking resources for individual pages within each page-type (2020). In this step, RUM data is collected from actual user interactions or synthetic monitoring, providing detailed feedback on how pages load. The RUM data is used to validate, update, and refine the list of distinct blocking resources for each individual page. The method may further include processing a user request for a webpage to predict blocking resources from the common blocking resources and the refined distinct blocking resources for the requested webpage (2030). When a user requests a specific webpage, the method determines the page type and retrieves the associated common blocking resources. It then combines these with the refined distinct blocking resources identified for that particular page, resulting in a comprehensive set of predicted blocking resources. This set can be used to generate optimization hints.

Certain further aspects of the computer-implemented method 2000 are described following, any one or more of which may be present in certain embodiments.

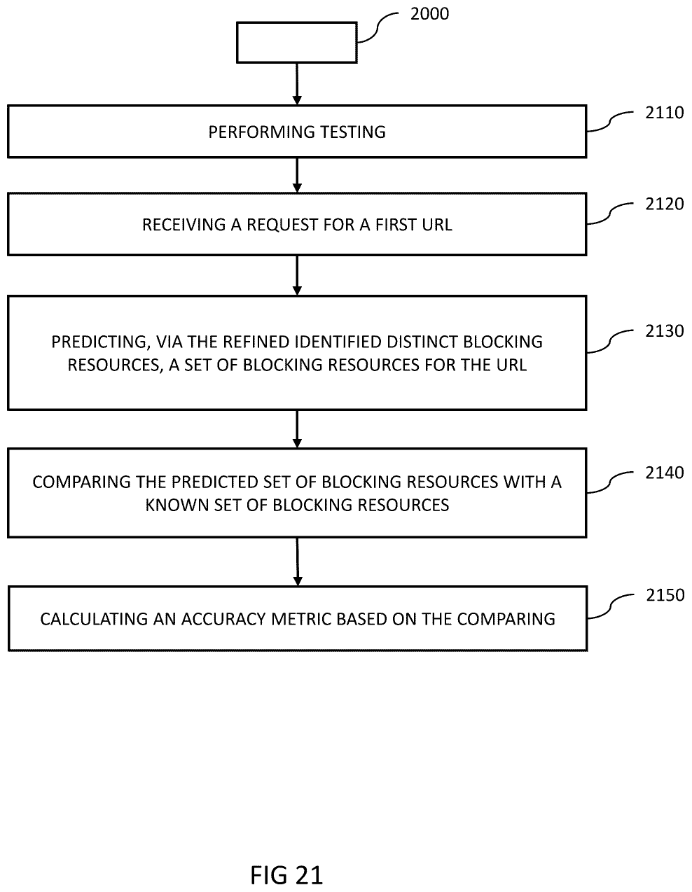

Referring to FIG. 21, the computer-implemented method 2000 may further include performing testing 2110 by: receiving a request for a first URL 2120; predicting, via the refined identified distinct blocking resources, a set of blocking resources for the URL 2130; comparing the predicted set of blocking resources with a known set of blocking resources 2140; and calculating an accuracy metric based on the comparing 2150.

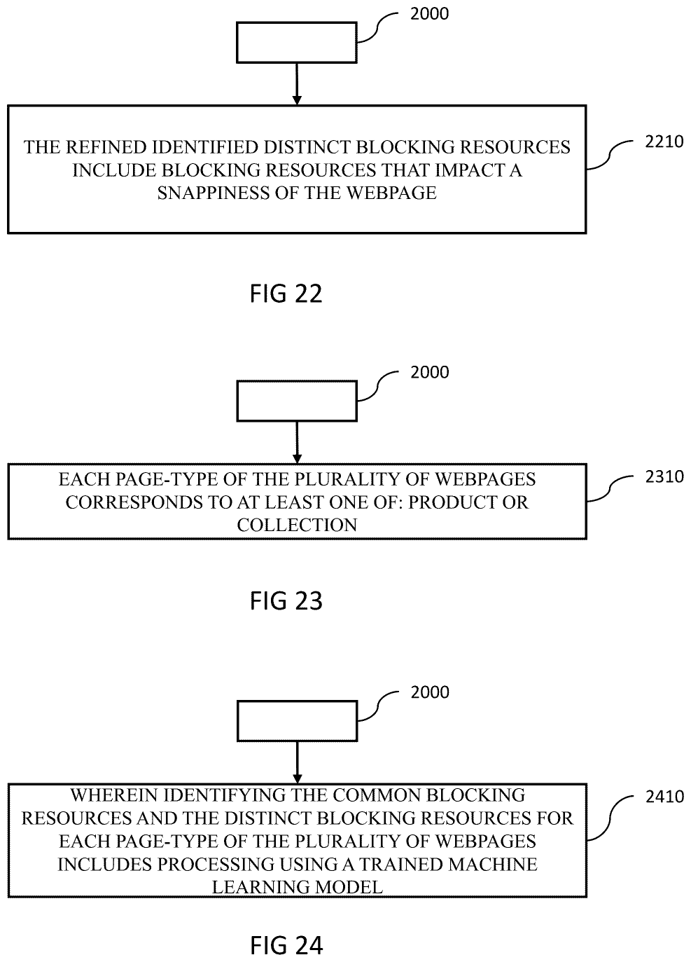

Referring to FIG. 22, the computer-implemented method 2000 may include, wherein the refined identified distinct blocking resources include blocking resources that impact a snappiness of the webpage 2210.

Referring to FIG. 23, the computer-implemented method 2000 may include, wherein each page-type of the plurality of webpages corresponds to at least one of: product or collection 2310.

Referring to FIG. 24, the computer-implemented method 2000 may include, wherein identifying the common blocking resources and the distinct blocking resources for each page-type of the plurality of webpages includes processing using a trained machine learning model 2410.

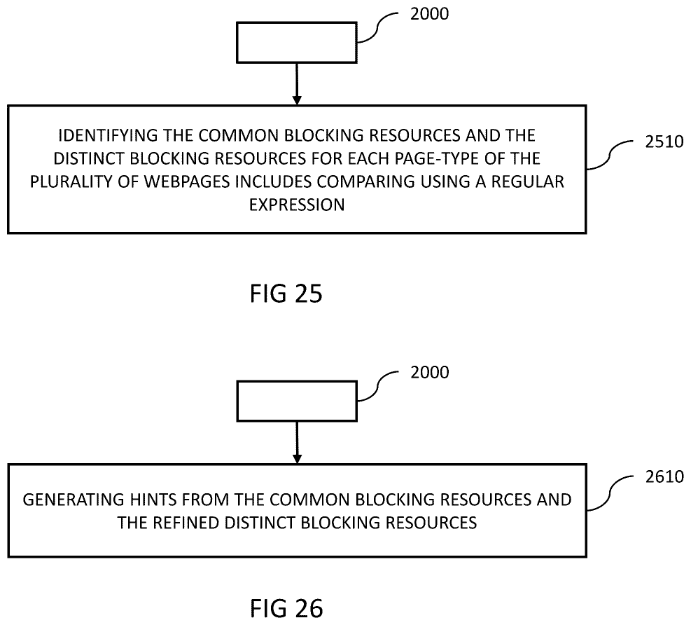

Referring to FIG. 25, the computer-implemented method 2000 may include, wherein identifying the common blocking resources and the distinct blocking resources for each page-type of the plurality of webpages includes comparing using a regular expression 2510.

Referring to FIG. 26, the computer-implemented method 2000 may further include generating hints from the common blocking resources and the refined distinct blocking resources 2610.

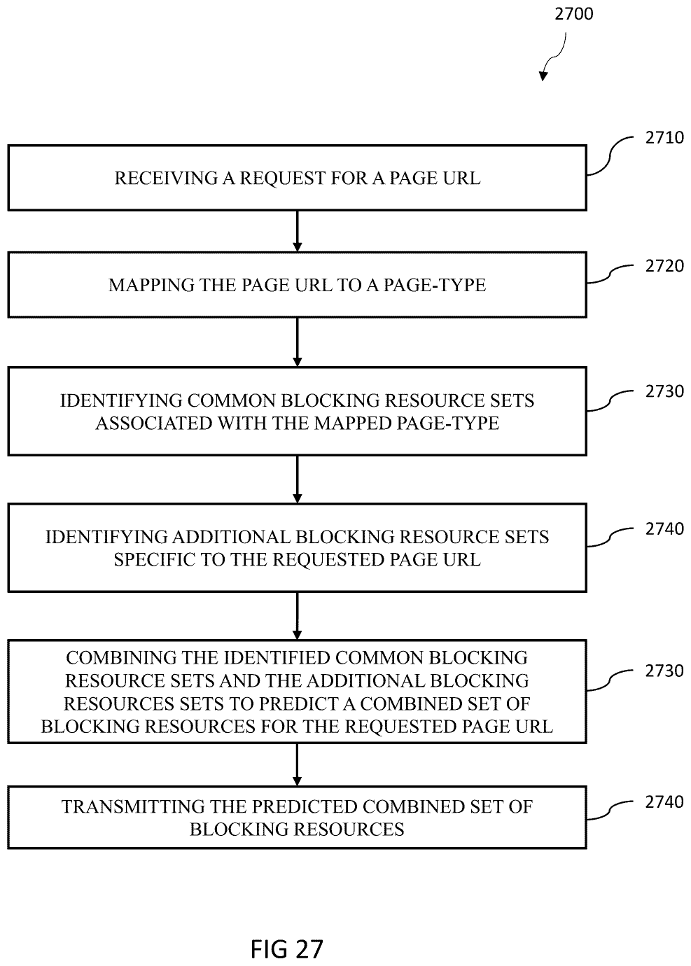

Referring to FIG. 27, a computer-implemented method 2700 may be provided. The method may include receiving a request for a page URL (2710). In this step, the method detects or is provided with a request from a user or client device for a specific webpage within the domain, typically identified by its unique URL. The method may include mapping the page URL to a page-type (2720). The method analyzes the structure or features of the requested URL and applies previously established classification rules, such as regular expressions or machine learning models, to determine the corresponding page type (e.g., product page, collection page, or informational page). The method may further include identifying common blocking resource sets associated with the mapped page-type (2730). The method retrieves the set of blocking resources that are common to all pages of the identified page type. These may include shared stylesheets, scripts, or layout elements that are essential for rendering any page of that type.

In embodiments, the method may include identifying additional blocking resource sets specific to the requested page URL (2740). The method determines if there are any unique or page-specific blocking resources required for the requested page, such as product-specific images, dynamic content, or custom scripts, by referencing stored data or applying inference algorithms based on patterns observed in similar pages. Afterward, the method may include combining the identified common blocking resource sets and the additional blocking resource sets to predict a combined set of blocking resources for the requested page URL (2750). The method merges the common and unique resource sets to form a comprehensive list of all resources that are necessary for optimal rendering of the requested page. Finally, the method may include transmitting the predicted combined set of blocking resources (2760). The method communicates this set, which may be in the form of optimization hints such as prefetch, preload, or prioritization directives, to the requesting client device or browser.

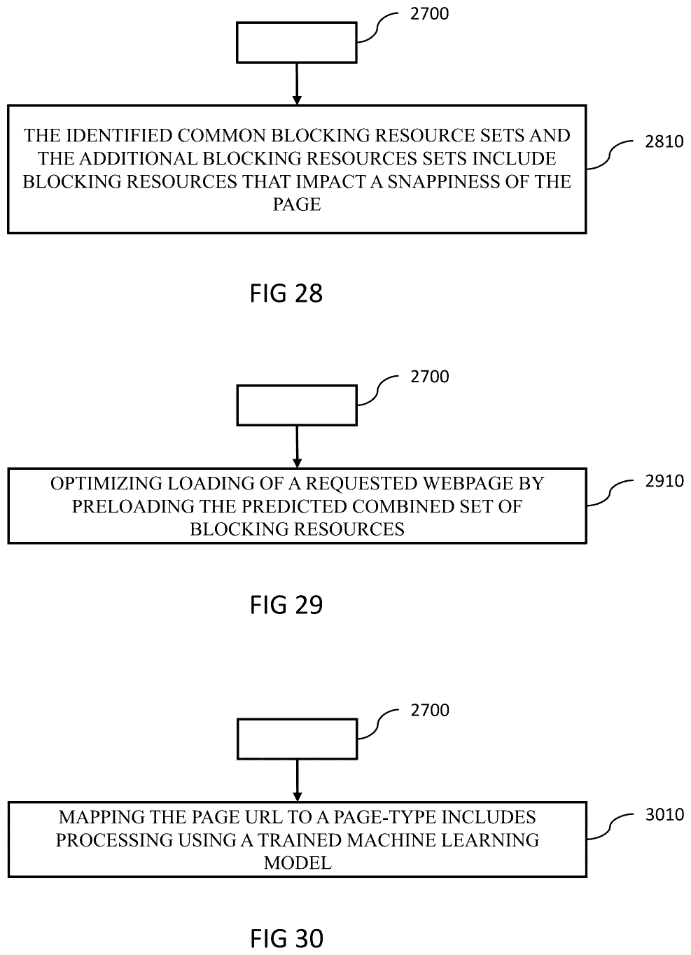

Referring to FIG. 28, the computer-implemented method 2700 may include, wherein the identified common blocking resource sets and the additional blocking resources sets include blocking resources that impact a snappiness of the page 2810.

Referring to FIG. 29, the computer-implemented method 2700 may further include, optimizing loading of a requested webpage by preloading the predicted combined set of blocking resources 2910.

Referring to FIG. 30, the computer-implemented method 2700 may include, wherein mapping the page URL to a page-type includes processing using a trained machine learning model 3010.

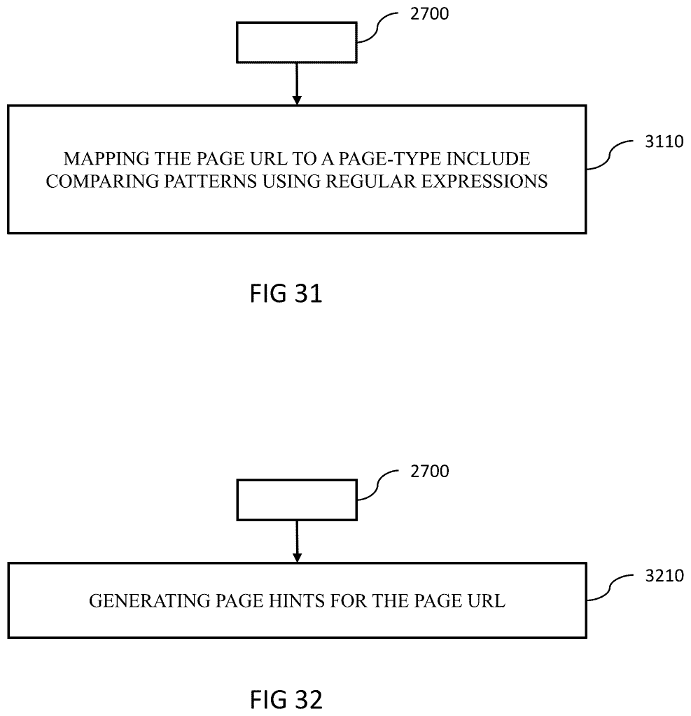

Referring to FIG. 31, the computer-implemented method 2700 may include, wherein mapping the page URL to a page-type includes comparing patterns using regular expressions 3110.

Referring to FIG. 32, the computer-implemented method 2700 may further include generating page hints for the page URL 3210.

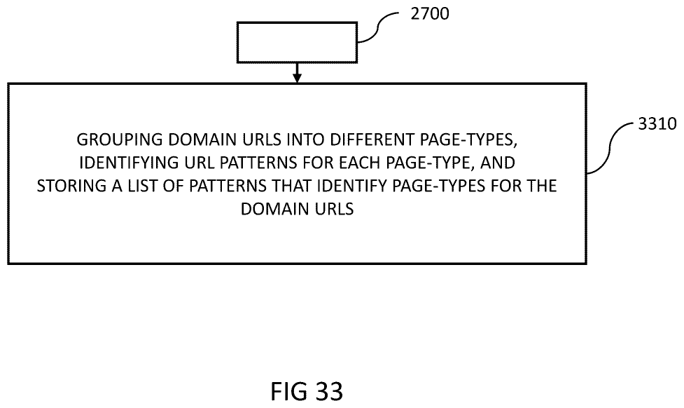

Referring to FIG. 33, the computer-implemented method 2700 may include, wherein mapping the page URL to the page-type includes grouping domain URLs into different page-types, identifying URL patterns for each page-type, and storing a list of patterns that identify page-types for the domain URLs 3310.

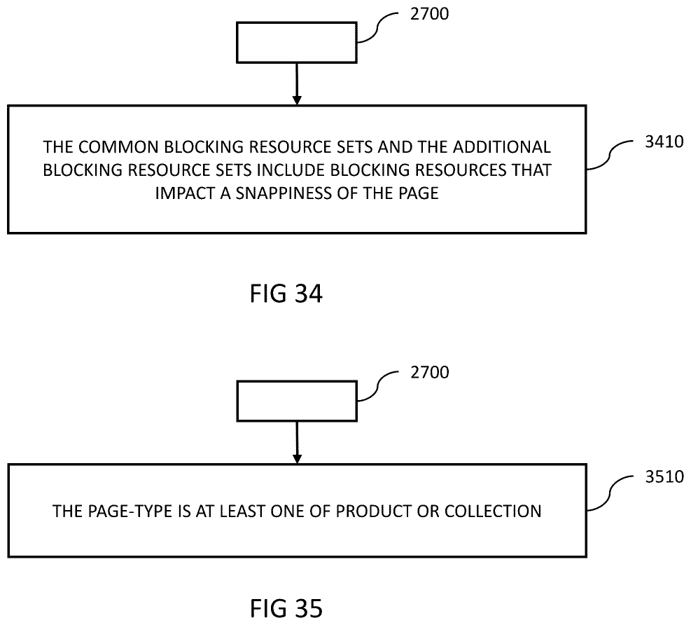

Referring to FIG. 34, the computer-implemented method 2700 may include, wherein the common blocking resource sets and the additional blocking resource sets include blocking resources that impact a snappiness of the page 3410.

Referring to FIG. 35, the computer-implemented method 2700 may include, wherein the page-type is at least one of product or collection 3510.

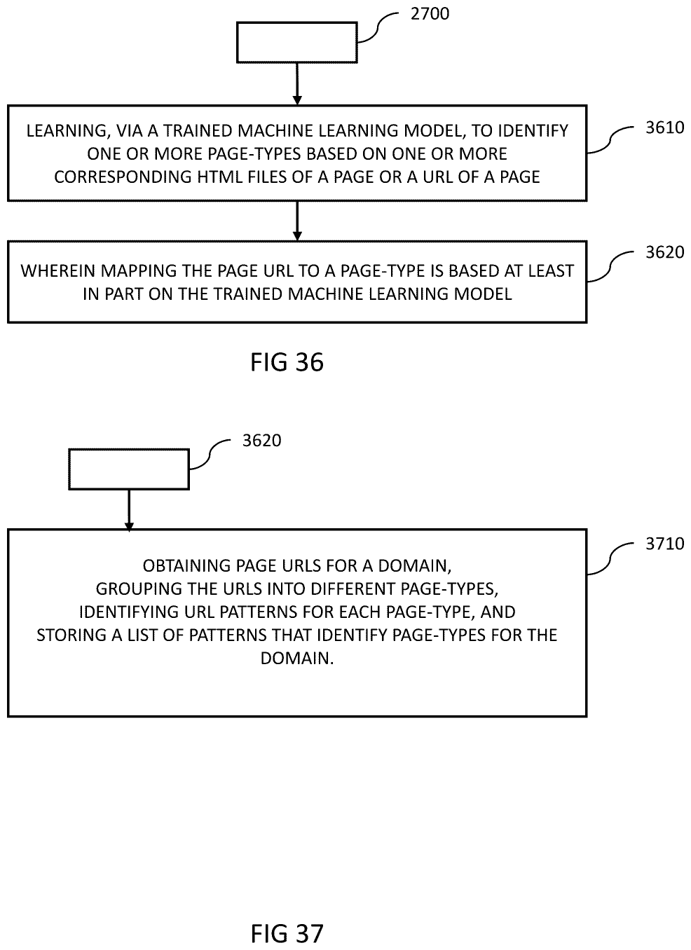

Referring to FIG. 36, the computer-implemented method 2700 may further include learning, via a trained machine learning model, to identify one or more page-types based on one or more corresponding HTML files of a page or a URL of a page 3610; wherein mapping the page URL to a page-type is based at least in part on the trained machine learning model 3620.

Referring to FIG. 37, the computer-implemented method 2700 may include learning, via a trained machine learning model, to identify one or more page-types based on one or more corresponding HTML files of a page or a URL of a page by obtaining page URLs for a domain, grouping the URLs into different page-types, identifying URL patterns for each page-type, and storing a list of patterns that identify page-types for the domain 3710.

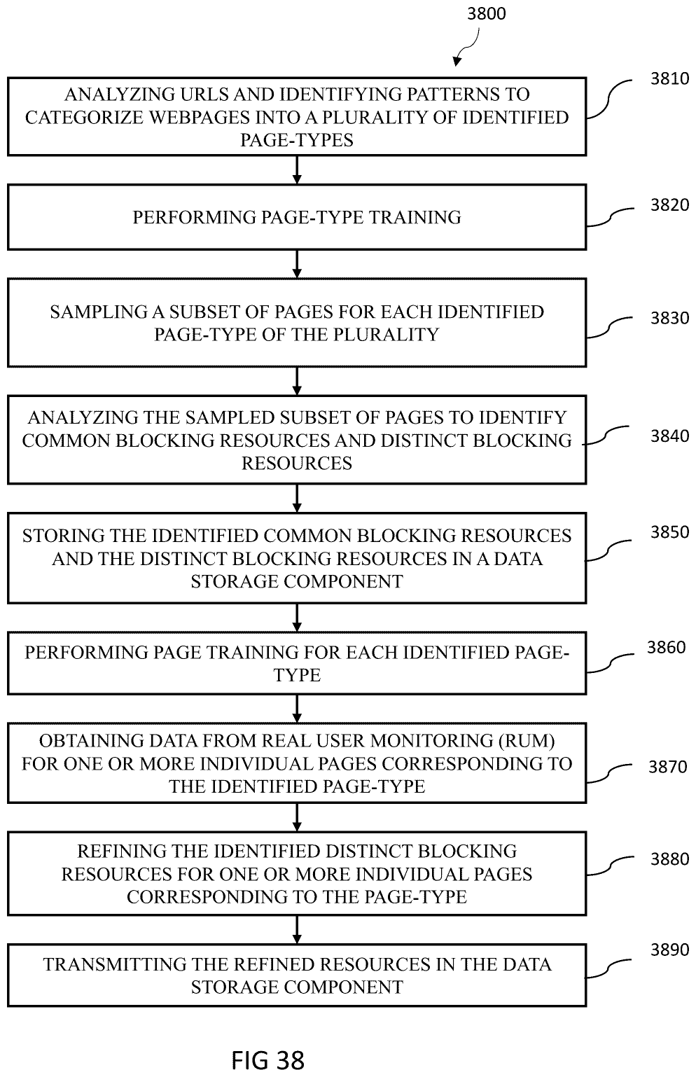

Referring to FIG. 38, a computer-implemented method 3800 for optimizing rendering of a webpage may be provided. The method may include analyzing URLs and identifying patterns to categorize webpages into a plurality of identified page types (3810). In this step, the method examines the structure of URLs across the domain, using techniques such as pattern matching, regular expressions, or machine learning models to detect recurring elements or tokens that indicate different page types (e.g., product pages, collection pages, or informational pages). The method may further include performing page-type training (3820), which includes several sub-steps. The method may involve sampling a subset of pages for each identified page type (3830). A representative sample is selected for each page type to ensure that the analysis captures the typical structure and resource requirements of that type. The sampled subset of pages is then analyzed to identify common blocking resources and distinct blocking resources unique to individual pages within the type (3840). These findings are then stored in a data storage component (3850), creating a reference database of common and unique resources for each page type.

The method may further perform page training for each identified page type (3860). This involves obtaining RUM data for one or more individual pages corresponding to the identified page type (3870). Using this data, the method refines the identified distinct blocking resources for one or more individual pages within the page type (3880), ensuring that the optimization strategy remains accurate and responsive to real-world conditions. The refined resources are then transmitted and stored in the data storage component (3890).

Certain further aspects of the computer-implemented method 3800 are described following, any one or more of which may be present in certain embodiments.

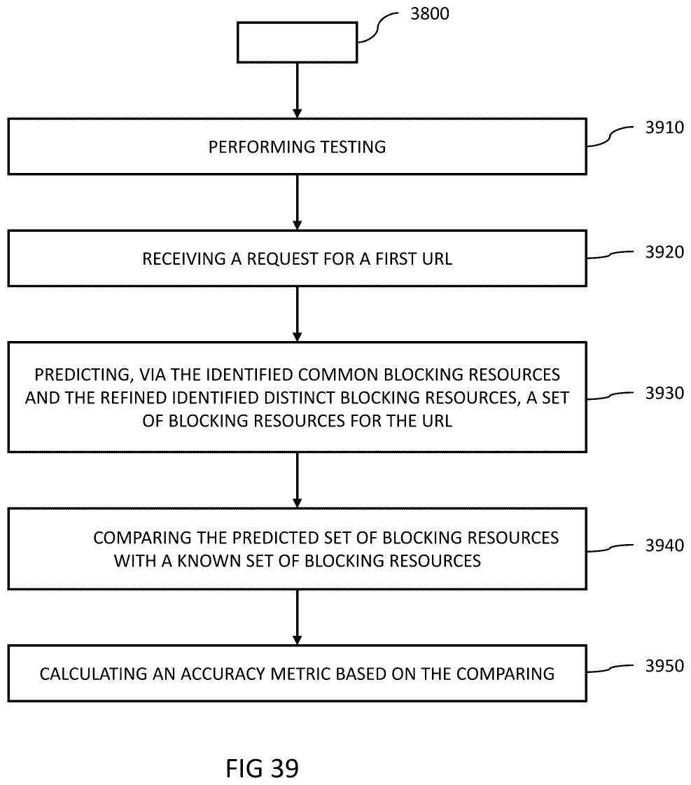

Referring to FIG. 39, the computer-implemented method 3800 may include performing testing 3910 by: receiving a request for a first URL 3920; predicting, via the identified common blocking resources and the refined identified distinct blocking resources, a set of blocking resources for the URL 3930; comparing the predicted set of blocking resources with a known set of blocking resources 3940; and calculating an accuracy metric based on the comparing 3950.

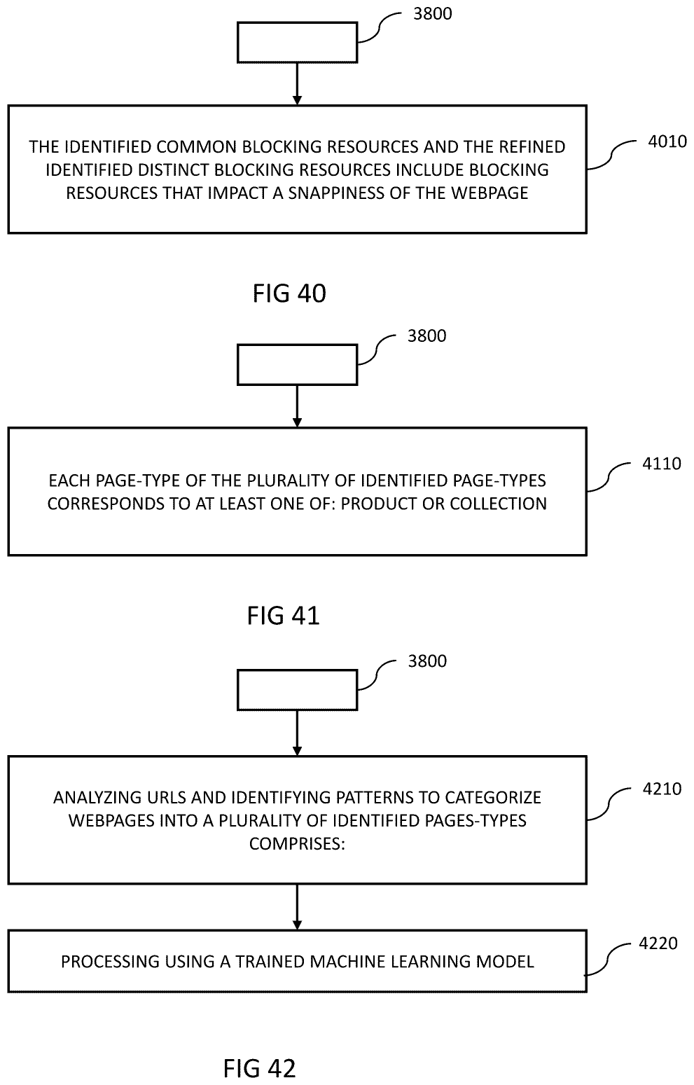

Referring to FIG. 40, the computer-implemented method 3800 may include, wherein the identified common blocking resources and the refined identified distinct blocking resources include blocking resources that impact a snappiness of the webpage 4010.

Referring to FIG. 41, the computer-implemented method 3800 may include, wherein each page-type of the plurality of identified page-types corresponds to at least one of product or collection 4110.

Referring to FIG. 42, the computer-implemented method 3800 may include, wherein analyzing URLs and identifying patterns to categorize webpages into a plurality of identified pages-types 4210 comprises processing using a trained machine learning model 4220.

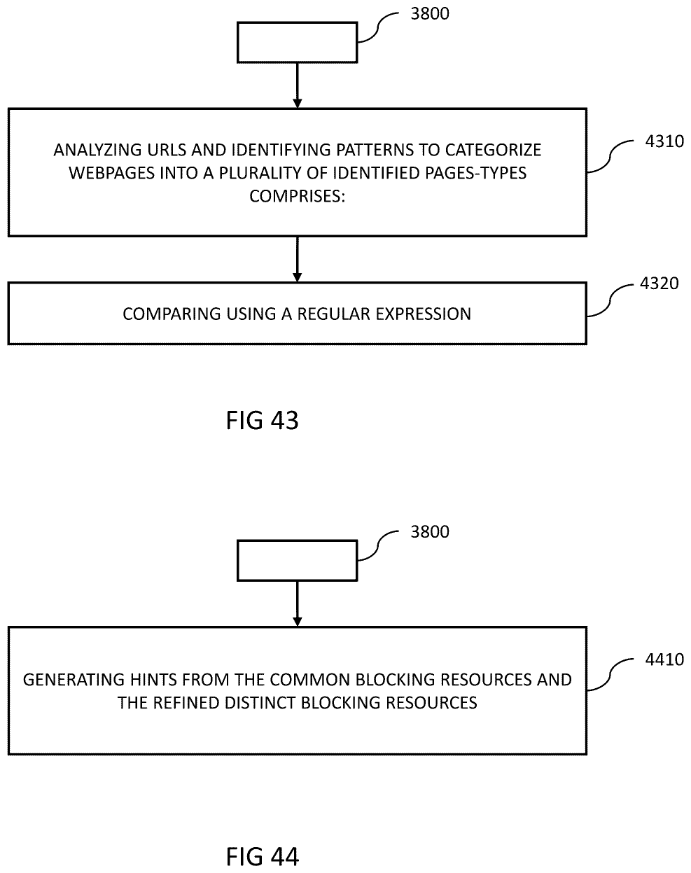

Referring to FIG. 43, the computer-implemented method 3800 may include, wherein analyzing URLs and identifying patterns to categorize webpages into a plurality of identified pages-types 4310 comprises comparing using a regular expression 4320.

Referring to FIG. 44, the computer-implemented method 3800 may further comprise generating hints from the common blocking resources and the refined distinct blocking resources 4410.

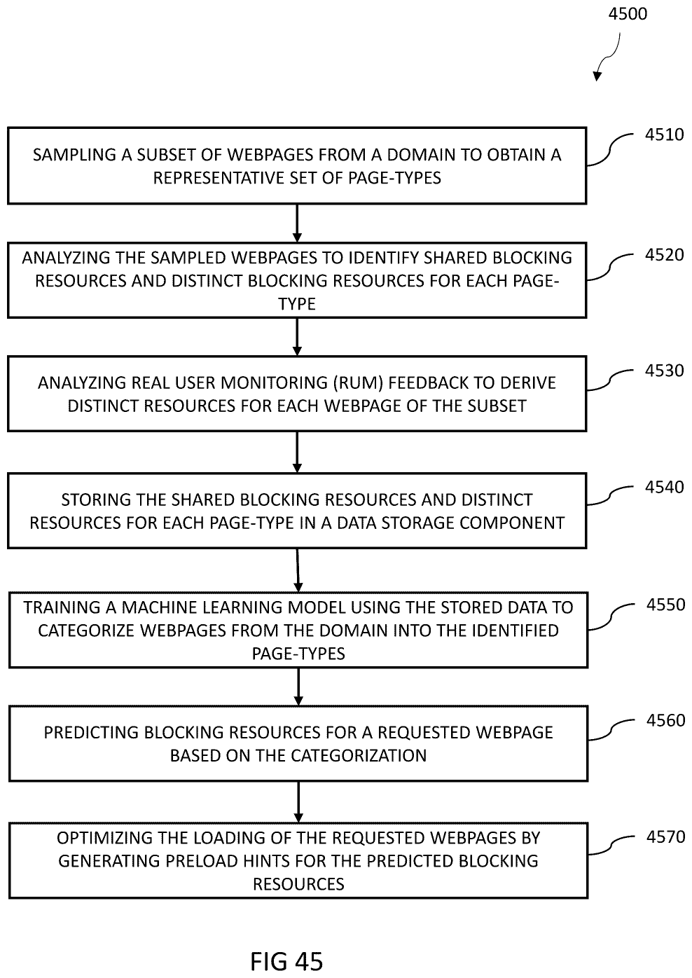

Referring to FIG. 45, a computer-implemented method 4500 for optimizing webpage loadings may be provided. The method may include sampling a subset of webpages from a domain to obtain a representative set of page-types (4510). Next, the method may include analyzing the sampled webpages to identify shared blocking resources and distinct blocking resources for each page-type (4520). Each sampled page is examined to determine which resources, such as CSS files, JavaScript files, images, or fonts, are required for rendering or significant events. The analysis distinguishes between blocking resources that are common to all pages of a given type (shared) and those that are unique to individual pages (distinct).

The method may further include analyzing RUM feedback to derive distinct resources for each webpage of the subset (4530). RUM data, collected from actual user interactions or synthetic monitoring, is used to validate and refine the identification of distinct blocking resources. In embodiments, the method may further include storing the shared blocking resources and distinct resources for each page-type in a data storage component (4540). The results of the analysis are organized and saved in a database or other storage system, with each entry associated with its corresponding page type and, where applicable, individual page URLs.

In some embodiments, the method may include training a machine learning model using the stored data to categorize webpages from the domain into the identified page-types (4550). The stored data is used to train a model that can automatically classify new or existing webpages into the correct page type based on their structural features, URL patterns, or other relevant attributes. The method may include predicting blocking resources for a requested webpage based on the categorization (4560). When a new page is requested, the trained model is used to determine its page type, and the method retrieves the associated shared and distinct blocking resources, either from storage or by applying inference algorithms. Finally, the method may include optimizing the loading of the requested webpages by generating preload hints for the predicted blocking resources (4570).

Certain further aspects of the computer-implemented method 4500 are described following, any one or more of which may be present in certain embodiments.

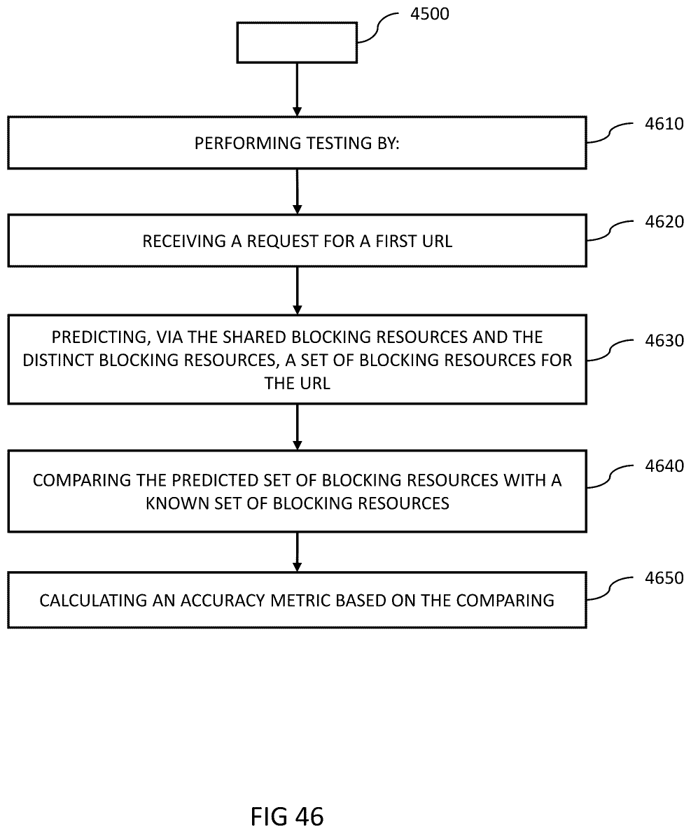

Referring to FIG. 46, the computer-implemented method 4500 may further include performing testing 4610 by: receiving a request for a first URL 4620; predicting, via the shared blocking resources and the distinct blocking resources, a set of blocking resources for the URL 4630; comparing the predicted set of blocking resources with a known set of blocking resources 4640; and calculating an accuracy metric based on the comparing 4650.

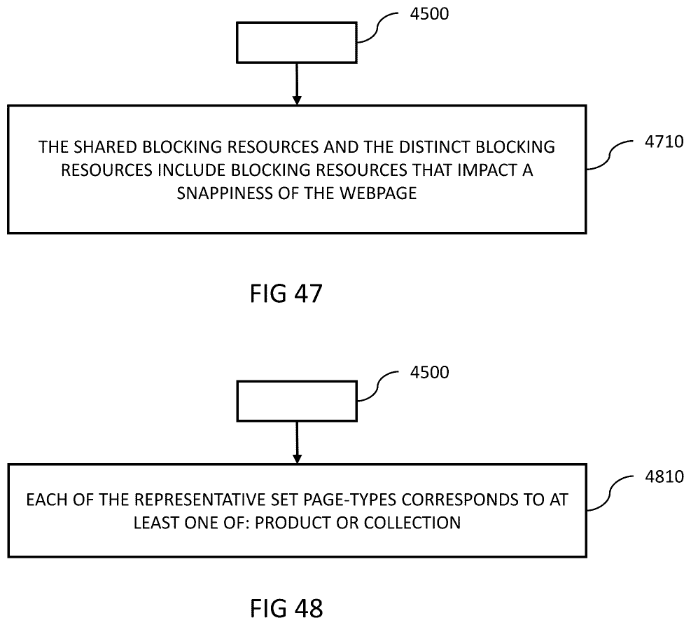

Referring to FIG. 47, the computer-implemented method 4500 may include, wherein the shared blocking resources and the distinct blocking resources include blocking resources that impact a snappiness of the webpage 4710.

Referring to FIG. 48, the computer-implemented method 4500 may include, wherein each of the representative set page-types corresponds to at least one of: product or collection 4810.

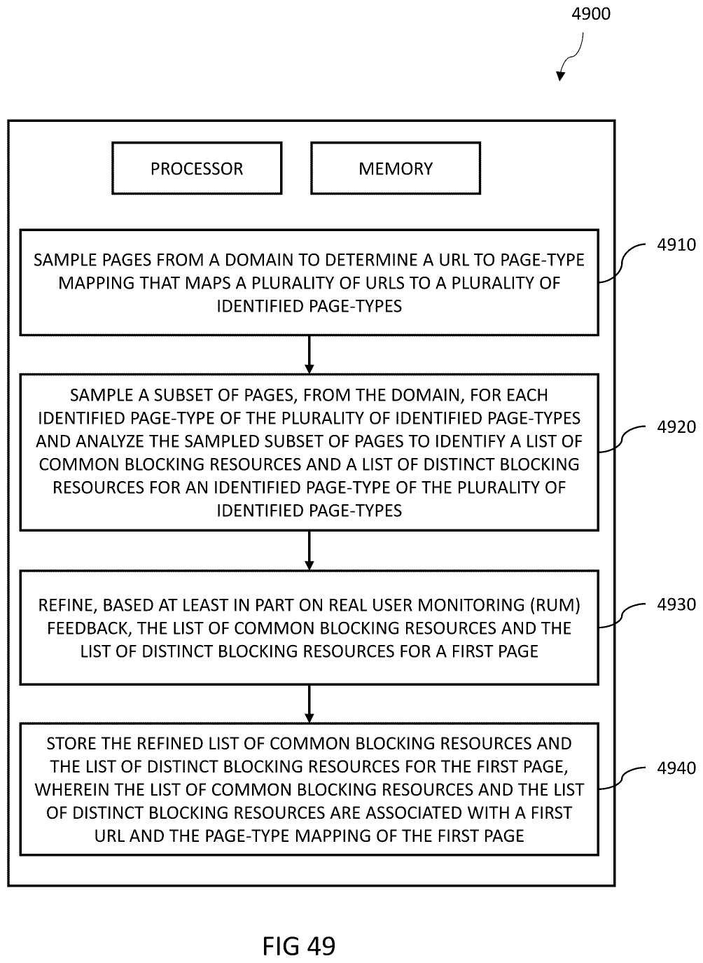

Referring to FIG. 49, an apparatus 4900 may be provided. The apparatus, including at least one processor; and a memory device that stores an application that, when loaded into the at least one processor, may cause the at least one processor to sample pages from a domain to determine a URL to page-type mapping that maps a plurality of URLs to a plurality of identified page-types 4910. The apparatus may be further configured to sample a subset of pages, from the domain, for each identified page-type of the plurality and analyzing the sampled subset of pages to identify a list of common blocking resources and a list of distinct blocking resources for an identified page-type of the plurality of identified page-types 4920. In embodiments, the apparatus may refine, based at least in part on RUM feedback data, the list of common blocking resources and the list of distinct blocking resources for a page 4930 and store the refined list of common blocking resources and the list of distinct blocking resources for the page, wherein the list of common blocking resources and the list of distinct blocking resources are associated with a URL and the page-type mapping of the page 4940.

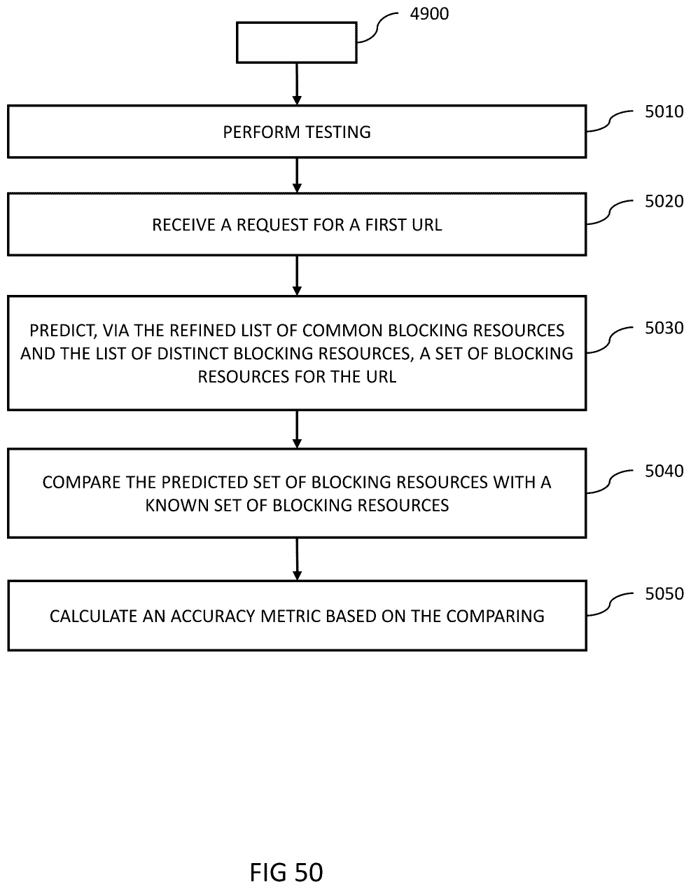

Referring to FIG. 50, the apparatus 4900 may further perform testing 5010 by receiving a request for a first URL 5020; predict, via the refined list of common blocking resources and the list of distinct blocking resources, a set of blocking resources for the URL 5030; compare the predicted set of blocking resources with a known set of blocking resources 5040; and calculate an accuracy metric based on the comparing 5050.

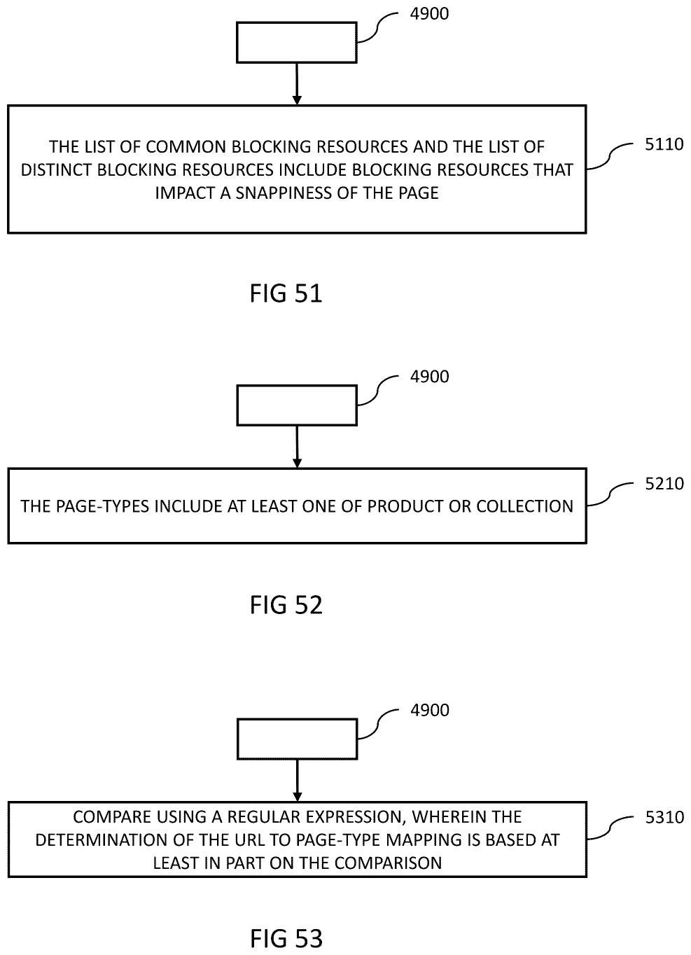

Referring to FIG. 51, the apparatus 4900 may, wherein the list of common blocking resources and the list of distinct blocking resources include blocking resources that impact a snappiness of the page 5110.

Referring to FIG. 52, the apparatus 4900 may include, wherein the page-types include at least one of product or collection 5210.

Referring to FIG. 53, the apparatus 4900 may compare using a regular expression, wherein the determination of the URL to page-type mapping is based at least in part on the comparison 5310.

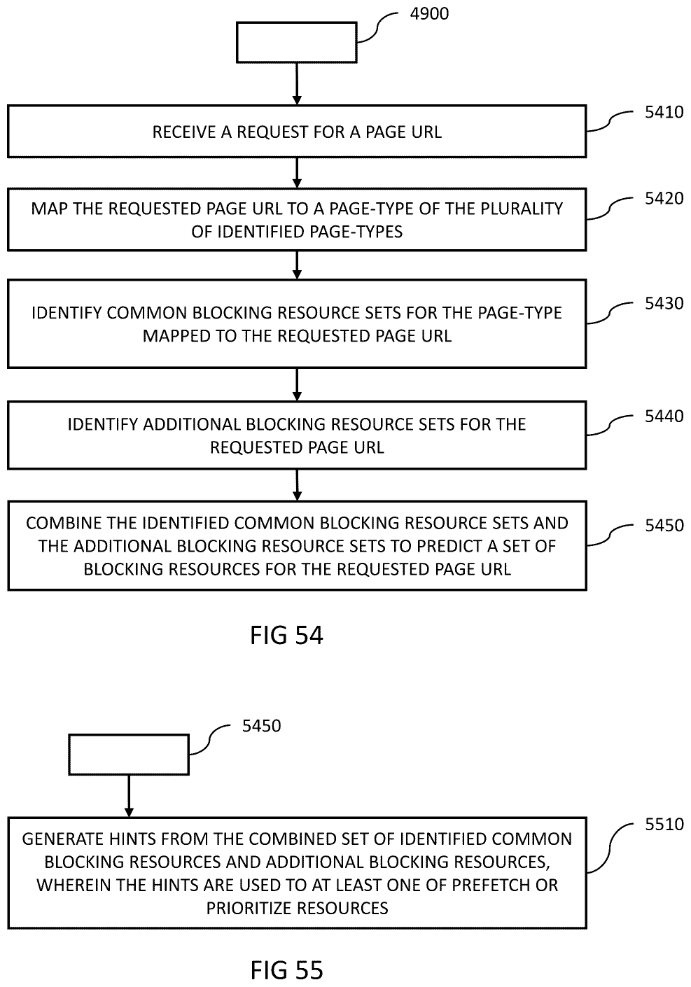

Referring to FIG. 54, the apparatus 4900 may receive a request for a page URL 5410; map the requested page URL to a page-type of the plurality of identified page-types 5420; identify common blocking resource sets for the page-type mapped to the requested page URL 5430; identify additional blocking resource sets for the requested page URL 5440; and combine the identified common blocking resource sets and the additional blocking resource sets to predict a set of blocking resources for the requested page URL 5450. Referring to FIG. 55, the apparatus 4900 may, wherein the application further causes the at least one processor to: generate hints from the combined set of identified common blocking resources and additional blocking resources, wherein the hints are used to at least one of prefetch or prioritize resources 5510.

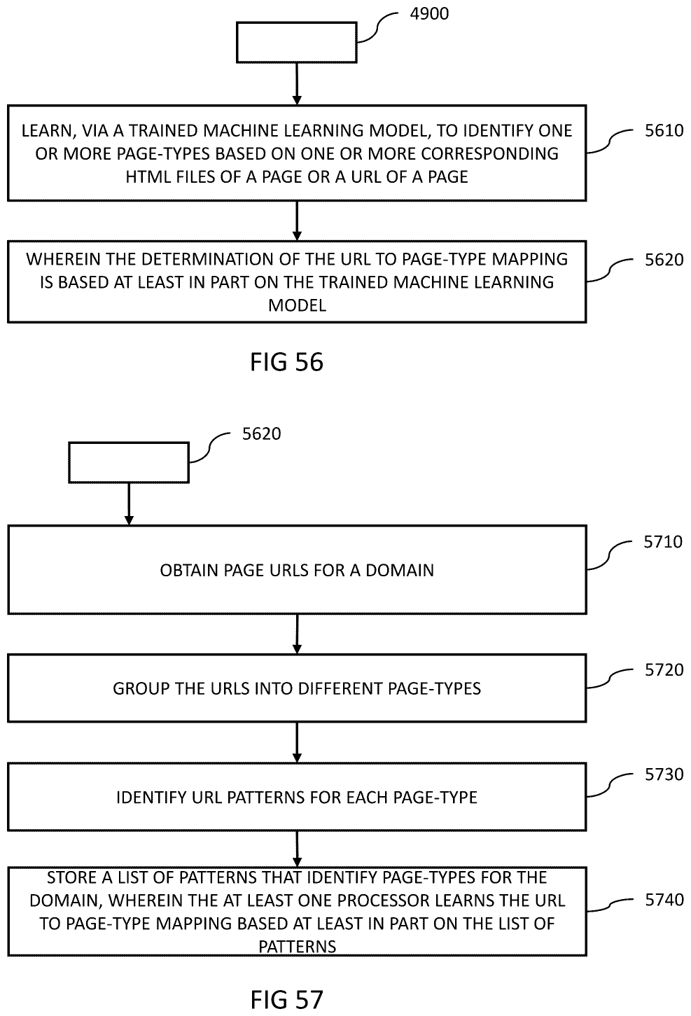

Referring to FIG. 56, the apparatus 4900 may learn, via a trained machine learning model, to identify one or more page-types based on one or more corresponding HTML files of a page or a URL of a page 5610, wherein the determination of the URL to page-type mapping is based at least in part on the trained machine learning model 5620. Referring to FIG. 57, the apparatus 4900 may obtain page URLs for a domain 5710; group the URLs into different page-types 5720; identify URL patterns for each page-type 5730; and store a list of patterns that identify page-types for the domain 5740, wherein the at least one processor learns the URL to page-type mapping based at least in part on the list of patterns.

As described herein, machine learning models may be trained using supervised learning or unsupervised learning. In supervised learning, a model is generated using a set of labeled examples, where each example has corresponding target label(s). In unsupervised learning, the model is generated using unlabeled examples. The collection of examples constructs a dataset, usually referred to as a training dataset. During training, a model is generated using this training data to learn the relationship between examples in the dataset. The training process may include various phases such as data collection, preprocessing, feature extraction, model training, model evaluation, and model fine-tuning. The data collection phase may include collecting a representative dataset, typically from multiple users, that covers the range of possible scenarios and positions. The preprocessing phase may include cleaning and preparing the examples in the dataset and may include filtering, normalization, and segmentation. The feature extraction phase may include extracting relevant features from examples to capture relevant information for the task. The model training phase may include training a machine learning model on the preprocessed and feature-extracted data. Models may include support vector machines (SVMs), artificial neural networks (ANNs), decision trees, and the like for supervised learning, or autoencoders, Hopfield, restricted Boltzmann machine (RBM), deep belief, Generative Adversarial Networks (GAN), or other networks, or clustering for unsupervised learning. The model evaluation phase may include evaluating the performance of the trained model on a separate validation dataset to ensure that it generalizes well to new and unseen examples. The model fine-tuning may include refining a model by adjusting its parameters, changing the features used, or using a different machine-learning algorithm, based on the results of the evaluation. The process may be iterated until the performance of the model on the validation dataset is satisfactory and the trained model can then be used to make predictions.

In embodiments, trained models may be periodically fine-tuned for specific user groups, applications, and/or tasks. Fine-tuning of an existing model may improve the performance of the model for an application while avoiding completely retraining the model for the application.

In embodiments, fine-tuning a machine learning model may involve adjusting its hyperparameters or architecture to improve its performance for a particular user group or application. The process of fine-tuning may be performed after initial training and evaluation of the model, and it can involve one or more hyperparameter tuning and architectural methods.

Hyperparameter tuning includes adjusting the values of the model's hyperparameters, such as learning rate, regularization strength, or the number of hidden units. This can be done using methods such as grid search, random search, or Bayesian optimization.

Architecture modification may include modifying the structure of the model, such as adding or removing layers, changing the activation functions, or altering the connections between neurons, to improve its performance.

Online training of machine learning models includes a process of updating the model as new examples become available, allowing it to adapt to changes in the data distribution over time. In online training, the model is trained incrementally as new data becomes available, allowing it to adapt to changes in the data distribution over time. Online training can also be useful for user groups that have changing usage habits of the stimulation device, allowing the models to be updated in almost real-time.

In embodiments, online training may include adaptive filtering. In adaptive filtering, a machine learning model is trained online to learn the underlying structure of the new examples and remove noise or artifacts from the examples.

The methods and systems described herein may be deployed in part or in whole through a machine having a computer, computing device, processor, circuit, and/or server that executes computer-readable instructions, program codes, instructions, and/or includes hardware configured to functionally execute one or more operations of the methods and systems disclosed herein. The terms computer, computing device, processor, circuit, and/or server, as utilized herein, should be understood broadly.

Any one or more of the terms computer, computing device, processor, circuit, and/or server include a computer of any type, capable to access instructions stored in communication thereto such as upon a non-transient computer readable medium, whereupon the computer performs operations of systems or methods described herein upon executing the instructions. In certain embodiments, such instructions themselves comprise a computer, computing device, processor, circuit, and/or server. Additionally or alternatively, a computer, computing device, processor, circuit, and/or server may be a separate hardware device, one or more computing resources distributed across hardware devices, and/or may include such aspects as logical circuits, embedded circuits, sensors, actuators, input and/or output devices, network and/or communication resources, memory resources of any type, processing resources of any type, and/or hardware devices configured to be responsive to determined conditions to functionally execute one or more operations of systems and methods herein.

Network resources and/or communication resources include, without limitation, local area network, wide area network, wireless, internet, or any other known communication resources and protocols. Example and non-limiting hardware, computers, computing devices, processors, circuits, and/or servers include, without limitation, a general-purpose computer, a server, an embedded computer, a mobile device, a virtual machine, and/or an emulated version of one or more of these. Example and non-limiting hardware, computers, computing devices, processors, circuits, and/or servers may be physical, logical, or virtual. A computer, computing device, processor, circuit, and/or server may be a distributed resource included as an aspect of several devices; and/or included as an interoperable set of resources to perform described functions of the computer, computing device, processor, circuit, and/or server, such that the distributed resources function together to perform the operations of the computer, computing device, processor, circuit, and/or server. In certain embodiments, each computer, computing device, processor, circuit, and/or server may be on separate hardware, and/or one or more hardware devices may include aspects of more than one computer, computing device, processor, circuit, and/or server, for example as separately executable instructions stored on the hardware device, and/or as logically partitioned aspects of a set of executable instructions, with some aspects of the hardware device comprising a part of a first computer, computing device, processor, circuit, and/or server, and some aspects of the hardware device comprising a part of a second computer, computing device, processor, circuit, and/or server.

A computer, computing device, processor, circuit, and/or server may be part of a server, client, network infrastructure, mobile computing platform, stationary computing platform, or other computing platform. A processor may be any kind of computational or processing device capable of executing program instructions, codes, binary instructions, and the like. The processor may be or include a signal processor, digital processor, embedded processor, microprocessor, or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions, and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache, and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer-readable instructions on a server, client, firewall, gateway, hub, router, or other such computer and/or networking hardware. The computer readable instructions may be associated with a server that may include a file server, print server, domain server, internet server, intranet server and other variants such as secondary server, host server, distributed server, and the like. The server may include one or more of memories, processors, computer readable transitory and/or non-transitory media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, and the like. Additionally, this coupling and/or connection may facilitate remote execution of instructions across the network. The networking of some or all of these devices may facilitate parallel processing of program code, instructions, and/or programs at one or more locations without deviating from the scope of the disclosure. In addition, all the devices attached to the server through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods, program code, instructions, and/or programs may be associated with a client that may include a file client, print client, domain client, internet client, intranet client and other variants such as secondary client, host client, distributed client, and the like. The client may include one or more of memories, processors, computer readable transitory and/or non-transitory media, storage media, ports (physical and virtual), communication devices, and interfaces capable of accessing other clients, servers, machines, and devices through a wired or a wireless medium, and the like. The methods, program code, instructions, and/or programs as described herein and elsewhere may be executed by the client. In addition, other devices utilized for execution of methods as described in this application may be considered as a part of the infrastructure associated with the client.

The client may provide an interface to other devices including, without limitation, servers, other clients, printers, database servers, print servers, file servers, communication servers, distributed servers, and the like. Additionally, this coupling and/or connection may facilitate remote execution of methods, program code, instructions, and/or programs across the network. The networking of some or all of these devices may facilitate parallel processing of methods, program code, instructions, and/or programs at one or more locations without deviating from the scope of the disclosure. In addition, all the devices attached to the client through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules, and/or components as known in the art. The computing and/or non-computing device(s) associated with the network infrastructure may include, apart from other components, a storage medium such as flash memory, buffer, stack, RAM, ROM, and the like. The methods, program code, instructions, and/or programs described herein and elsewhere may be executed by one or more of the network infrastructural elements.

The methods, program code, instructions, and/or programs described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like.

The methods, program code, instructions, and/or programs described herein and elsewhere may be implemented on or through mobile devices. The mobile devices may include navigation devices, cell phones, mobile phones, mobile personal digital assistants, laptops, palmtops, netbooks, pagers, electronic books readers, music players, and the like. These mobile devices may include, apart from other components, a storage medium such as a flash memory, buffer, RAM, ROM and one or more computing devices. The computing devices associated with mobile devices may be enabled to execute methods, program code, instructions, and/or programs stored thereon. Alternatively, the mobile devices may be configured to execute instructions in collaboration with other devices. The mobile devices may communicate with base stations interfaced with servers and configured to execute methods, program code, instructions, and/or programs. The mobile devices may communicate on a peer to peer network, mesh network, or other communications network. The methods, program code, instructions, and/or programs may be stored on the storage medium associated with the server and executed by a computing device embedded within the server. The base station may include a computing device and a storage medium. The storage device may store methods, program code, instructions, and/or programs executed by the computing devices associated with the base station.

The methods, program code, instructions, and/or programs may be stored and/or accessed on machine readable transitory and/or non-transitory media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

Certain operations described herein include interpreting, receiving, and/or determining one or more values, parameters, inputs, data, or other information. Operations including interpreting, receiving, and/or determining any value parameter, input, data, and/or other information include, without limitation: receiving data via a user input; receiving data over a network of any type; reading a data value from a memory location in communication with the receiving device; utilizing a default value as a received data value; estimating, calculating, or deriving a data value based on other information available to the receiving device; and/or updating any of these in response to a later received data value. In certain embodiments, a data value may be received by a first operation, and later updated by a second operation, as part of the receiving a data value. For example, when communications are down, intermittent, or interrupted, a first operation to interpret, receive, and/or determine a data value may be performed, and when communications are restored an updated operation to interpret, receive, and/or determine the data value may be performed.

Certain logical groupings of operations herein, for example methods or procedures of the current disclosure, are provided to illustrate aspects of the present disclosure. Operations described herein are schematically described and/or depicted, and operations may be combined, divided, re-ordered, added, or removed in a manner consistent with the disclosure herein. It is understood that the context of an operational description may require an ordering for one or more operations, and/or an order for one or more operations may be explicitly disclosed, but the order of operations should be understood broadly, where any equivalent grouping of operations to provide an equivalent outcome of operations is specifically contemplated herein. For example, if a value is used in one operational step, the determining of the value may be required before that operational step in certain contexts (e.g. where the time delay of data for an operation to achieve a certain effect is important), but may not be required before that operation step in other contexts (e.g. where usage of the value from a previous execution cycle of the operations would be sufficient for those purposes). Accordingly, in certain embodiments an order of operations and grouping of operations as described is explicitly contemplated herein, and in certain embodiments re-ordering, subdivision, and/or different grouping of operations is explicitly contemplated herein.

The methods and systems described herein may transform physical and/or intangible items from one state to another. The methods and systems described herein may also transform data representing physical and/or intangible items from one state to another.

The elements described and depicted herein, including in flow charts, block diagrams, and/or operational descriptions, depict and/or describe specific example arrangements of elements for purposes of illustration. However, the depicted and/or described elements, the functions thereof, and/or arrangements of these, may be implemented on machines, such as through computer executable transitory and/or non-transitory media having a processor capable of executing program instructions stored thereon, and/or as logical circuits or hardware arrangements. Example arrangements of programming instructions include at least: monolithic structure of instructions; standalone modules of instructions for elements or portions thereof; and/or as modules of instructions that employ external routines, code, services, and so forth; and/or any combination of these, and all such implementations are contemplated to be within the scope of embodiments of the present disclosure Examples of such machines include, without limitation, personal digital assistants, laptops, personal computers, mobile phones, other handheld computing devices, medical equipment, wired or wireless communication devices, transducers, chips, calculators, satellites, tablet PCS, electronic books, gadgets, electronic devices, devices having artificial intelligence, computing devices, networking equipment, servers, routers and the like. Furthermore, the elements described and/or depicted herein, and/or any other logical components, may be implemented on a machine capable of executing program instructions. Thus, while the foregoing flow charts, block diagrams, and/or operational descriptions set forth functional aspects of the disclosed systems, any arrangement of program instructions implementing these functional aspects are contemplated herein. Similarly, it will be appreciated that the various steps identified and described above may be varied, and that the order of steps may be adapted to particular applications of the techniques disclosed herein. Additionally, any steps or operations may be divided and/or combined in any manner providing similar functionality to the described operations. All such variations and modifications are contemplated in the present disclosure. The methods and/or processes described above, and steps thereof, may be implemented in hardware, program code, instructions, and/or programs or any combination of hardware and methods, program code, instructions, and/or programs suitable for a particular application. Example hardware includes a dedicated computing device or specific computing device, a particular aspect or component of a specific computing device, and/or an arrangement of hardware components and/or logical circuits to perform one or more of the operations of a method and/or system. The processes may be implemented in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and computer readable instructions, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or computer-readable instructions described above. All such permutations and combinations are contemplated in embodiments of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples but is to be understood in the broadest sense allowable by law.

What is claimed is:

1. A computer-implemented method, comprising:
sampling pages from a domain to determine a URL to page-type mapping that maps a plurality of URLs to a plurality of page-types;
sampling a subset of pages, from the domain, for each identified page-type of the plurality of page-types and analyzing the subset of pages to identify a list of common blocking resources and a list of distinct blocking resources for a page-type of the plurality of page-types;
refining, based at least in part on real user monitoring (RUM) feedback, the list of common blocking resources and the list of distinct blocking resources for a first page; and
storing the refined list of common blocking resources and the refined list of distinct blocking resources for the first page, wherein the list of common blocking resources and the list of distinct blocking resources are associated with a first URL and the page-type of the first page.

2. The computer-implemented method of claim 1 further comprising:
performing testing by:
receiving a request for a second URL;
predicting, from the refined list of common blocking resources and the refined list of distinct blocking resources, a set of blocking resources for the second URL;
comparing the set of blocking resources with a known set of blocking resources; and
calculating an accuracy metric based on the comparing.

3. The computer-implemented method of claim 1, wherein the list of common blocking resources and the list of distinct blocking resources include blocking resources that impact a snappiness of the first page.

4. The computer-implemented method of claim 1, wherein identifying distinct blocking resources comprises analyzing locations within a document object model (DOM) of the first page to extract resource identifiers.

5. The computer-implemented method of claim 1, wherein determining the URL to page-type mapping comprises receiving page-type information from RUM data.

6. The computer-implemented method of claim 1, wherein determining the URL to page-type mapping comprises:
receiving page-type classification data from an external analytics system; and
associating the received page-type classification with corresponding URLs.

7. The computer-implemented method of claim 6, wherein page-types include at least one of product or collection.

8. The computer-implemented method of claim 1, wherein determining the URL to page-type mapping comprises:
comparing the URL to page-type mapping using a regular expression.

9. The computer-implemented method of claim 1, further comprising:
receiving a request for a second URL;
mapping the second URL to a page-type of the plurality of page-types;
identifying common blocking resource sets for the page-type mapped to the second URL;
identifying distinct blocking resource sets for the second URL; and
combining the common blocking resource sets and the distinct blocking resource sets to predict a set of blocking resources for the second URL.

10. The computer-implemented method of claim 9, further comprising:
generating hints from the set of blocking resources for the second URL, wherein the hints are used to at least one of prefetch or prioritize resources.

11. The computer-implemented method of claim 1, further comprising:
learning, via a trained machine learning model, to identify one or more page-types based on one or more corresponding HTML files of a page or a URL of a page;
wherein the determination of the URL to page-type mapping is based at least in part on the trained machine learning model.

12. The computer-implemented method of claim 11, wherein learning the URL to page-type mapping comprises:
obtaining page URLs for the domain;
grouping the page URLs into different page-types;
identifying URL patterns for each page-type; and
storing a list of patterns that identify page-types for the domain.

13. An apparatus comprising:
at least one processor; and
a memory device that stores an application that, when loaded into the at least one processor, causes the at least one processor to:
sample pages from a domain to determine a URL to page-type mapping that maps a plurality of URLs to a plurality of identified page-types;
sample a subset of pages, from the domain, for each identified page-type of the plurality of identified page-types and analyze the sampled subset of pages to identify a list of common blocking resources and a list of distinct blocking resources for an identified page-type of the plurality of identified page-types;
refine, based at least in part on real user monitoring (RUM) feedback, the list of common blocking resources and the list of distinct blocking resources for a first page; and
store the refined list of common blocking resources and the list of distinct blocking resources for the first page, wherein the list of common blocking resources and the list of distinct blocking resources are associated with a first URL and the page-type mapping of the first page.

14. The apparatus of claim 13, wherein the application further causes the at least one processor to:
perform testing by:
receiving a request for a second URL;
predicting, via the refined list of common blocking resources and the list of distinct blocking resources, a set of blocking resources for the second URL;
comparing the set of blocking resources with a known set of blocking resources; and
calculating an accuracy metric based on the comparing.

15. The apparatus of claim 13, wherein the list of common blocking resources and the list of distinct blocking resources include blocking resources that impact snappiness of the page.

16. The apparatus of claim 13, wherein page-types include at least one of a product or a collection.

17. The apparatus of claim 13, wherein the application causes the at least one processor to:
compare using a regular expression, wherein the determination of the URL to page-type mapping is based at least in part on a comparison.

18. The apparatus of claim 13, wherein the application further causes the at least one processor to:
receive a request for a page URL;
map the page URL to a page-type of the plurality of identified page-types;
identify common blocking resource sets for the page-type mapped to the page URL;
identify additional blocking resource sets for the page URL; and
combine the identified common blocking resource sets and the additional blocking resource sets to predict a set of blocking resources for the page URL.

19. The apparatus of claim 18, wherein the application further causes the at least one processor to:
generate hints from the set of identified common blocking resources and additional blocking resources, wherein the hints are used to at least one of prefetch or prioritize resources.

20. The apparatus of claim 13, wherein the application further causes the at least one processor to;
learn, via a trained machine learning model, to identify one or more page-types based on one or more corresponding HTML files of a page or a URL of a page;
wherein the determination of the URL to page-type mapping is based at least in part on the trained machine learning model.

21. The apparatus of claim 20, wherein the application causes the at least one processor to:
obtain page URLs for the domain;
group the page URLs into different page-types;
identify URL patterns for each page-type; and
store a list of patterns that identify page-types for the domain;
wherein the at least one processor learns the URL to page-type mapping based at least in part on the list of patterns.
